(19) United States
(12) Patent Application Publication
(10) Pub. No.: US 2006/0125742 A1
(43) Pub. Date: Jun. 15, 2006

(54) Liquid-crystal display device and method of driving liquid-crystal display device

(76) Inventors: Yoshifumi Sekiguchi, Hitachiota (JP); Tsunenori Yamamoto, Hitachi (JP); Shoichi Hirota, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/285,194

(22) Filed: Nov. 23, 2005

(30) Foreign Application Priority Data
Nov. 26, 2004 (JP) 2004-342611

(51) Int. Cl. G09G 3/30

(52) U.S. Cl. 345/80

(57) ABSTRACT

A liquid-crystal display device and a method of driving the same which can suppress flicker to maintain an enhanced quality of picture, and can reduce its power consumption. A backlight unit is turned ON and OFF a plurality of times in synchronism with a frame period having a scanning period and a hold period longer than the scanning period. One turning ON and OFF period of the backlight corresponds to a backlight period having a length of 1/60 seconds or smaller. The backlight unit is turned ON and OFF four times in four backlight periods within one frame period. Thus, the display device can suppress flicker and reduce its power consumption.

### BACKGROUND OF THE INVENTION

The present invention relates to a display device for use in a mobile device such as a cellular phone and more particularly, to a liquid-crystal display device which can suppress flicker, display an image with a high picture quality, and reduce its power consumption, and also to a method for driving the liquid-crystal display device.

A method for suppressing a non-uniform transmissivity based on backlight control is disclosed in JP-A-2003-255914, wherein a system comprises a liquid crystal display panel, a backlight unit installed at the back of the display panel and having a plurality of light emitting sources, and a plurality of luminance value setting circuits for setting luminance values of the plurality of light emitting sources, and wherein the plurality of luminance value setting circuits adjust the luminances of the plurality of light emitting sources so as to cancel a non-uniform transmissivity appearing on the display of the liquid crystal display panel.

A method for driving a liquid-crystal display device is disclosed in JP-A-2001-312253 and JP-A-2004-206075, wherein a sum of a scanning period and a pause period during which all gate lines are put in a non-scan state, is regarded as one frame period.

### SUMMARY OF THE INVENTION

The technique disclosed in the above JP-A-2003-255914 fails to consider a driving method wherein a hold period having a length corresponding nearly to a scanning period is not provided in one frame, a flicker characteristic based on the driving method, and a method for suppressing flicker.

The above JP-A-2001-312253 and JP-A-2004-206075 also fail to take the backlight control, in particular, the flicker suppression based on the backlight control into consideration.

Problems to be solved by the present invention will be explained by referring to FIGS. 12A, 12B, and 12C. FIG. 12A shows a block diagram of a liquid-crystal display device. A liquid-crystal display device 1 has a liquid crystal panel 2, a source line driver 3, a gate driver 4, a power supply circuit 5, and a backlight unit 6.

In some cases, these circuits may be provided in separated LSIs or part or whole thereof may be provided in a common LSI. Or part or whole of the LSIs may be incorporated in the liquid crystal panel 2.

In the illustrated example, explanation will be made in connection with a case where these circuits are provided in separated LSIs. It is assumed that a matrix of pixels arranged in N rows and M columns (N and M being each an even number for simplicity) is arranged on the liquid crystal panel 2. It is also assumed that a display system is a normally open mode (white is displayed when no voltage is applied).

FIG. 12B shows an equivalent circuit of n rows and m columns of pixels, and FIG. 12C shows a schematic diagram of a frame-inversion driving method and optical responses OP₁, OP_{N/2}, and OP_{N} for pixels of the first, N/2-th, and N-th rows. Reference symbols V_{gl}, V_{gN/2}, and V_{gN} denote time variations in the voltages of the first, N/2-th, and N-th gate lines.

Explanation will be made as to the equivalent circuit shown in FIG. 12B. An active element is provided at an intersection of a data line 101 and a gate line 102, and the active element is a thin film transistor (which will be referred to merely as the TFT, hereinafter).

The gate lines 102 controls turning ON/OFF of the TFT. More specifically, the gate lines 102 controls the TFT in such a manner that, when the voltage V_{gn} of the n-th row gate line is at “HIGH” level (the voltage taking a value in a range from nearly 8V to nearly 15V), the TFT is in an ON state. Thus continuity is established between the data line 101 and a pixel electrode so that the voltage V_{dm} of the m-th gate line is applied to a pixel electrode 104.

When the voltage V_{dm} of the m-th gate line is at a level of “LOW” (the voltage taking a value in a range from about 0 V to about −15V), the TFT is in an OFF state. Thus a high-resistance state is established between the data line 101 and the pixel electrode 104 to hold the electric charges of the pixel. The TFT in the OFF state is expressed in the circuit by a resistance R_{off} connected between the data line 101 and the pixel electrode 104.

A liquid crystal is expressed by a parallel circuit of a liquid crystal capacitance C_{lc} and a liquid crystal resistance R_{lc}. Liquid crystal molecules move according to a voltage (referred to as the liquid crystal voltage, hereinafter) applied to the parallel circuit to exhibit a desired luminance. A storage capacitor C_{stg} for holding a charge is disposed between a capacitance wiring line 103 and the pixel electrode 104.

A parasitic capacitor C_{sd1} is present between the data line 101 connected to the TFT and the pixel electrode 104, and a parasitic capacitor C_{sd2} is present between a gate line opposed to the data line 101 and the pixel electrode. Further, a parasitic capacitor C_{gs} is present even between the pixel electrode 104 and the gate lines 102.

When the presence of a parasitic capacitor causes variation of the voltage of the data line 101 or the gate lines 102, capacitive coupling causes the voltage of the present embodiment to vary, thus causing variation of an optical response. Even when the TFT is in the OFF state, the presence of the resistance R_{off} and the R_{lc} causes a leakage current to flow, whereby the present embodiment voltage is fluctuated.

Explanation will be made as to the schematic diagram of driving method shown in FIG. 12C. The drawing shows a schematic diagram of driving method corresponding to continuous two frames. In one frame period Tf, a voltage V_{com} on a common electrode 100 takes V_{comH} or V_{comL}.

Assume that a frame when the voltage V_{com} of the common electrode takes V_{comL} is a positive frame, and a frame when the V_{com} of the common electrode takes V_{comH} is a negative frame. Then a liquid crystal voltage is written so that the polarity of the voltage becomes positive at desired timing. Similarly, the liquid crystal voltage is written so that the polarity of the voltage becomes negative at desired timing. The voltage V_{com} of the common electrode is inverted for each frame. The voltage V_{dm} of the gate line takes a value corresponding to an image data voltage.

FIGS. 12A, 12B and 12C show when image data of black is displayed on the entire surface of the liquid crystal panel for simplicity. The drawings also show when the luminance of the backlight is constant. In the case of a liquid-crystal display device, even when the black data image is displayed, such an optical response variation as shown in FIG. 12C takes place, because backlight leaks.

In switching between frames, the voltage V_{com} of the common electrode and the voltage V_{dm} of the gate line vary. Thus capacitive coupling causes even the liquid crystal voltage to vary. After frame switching, a leakage current causes the liquid crystal voltage to vary until the pixel is again scanned. Even a luminance to be displayed varies synchronously with a variation in the liquid crystal voltage while involving a delay based on a liquid crystal response.

As shown in FIG. 12C, pixels on the first row are less influenced upon frame switching, because the pixels are scanned quickly after the frame switching. Further the influence by the leakage current becomes large during holding of image data in a frame next to the frame to be scanned, because the common electrode voltage V_{com} and the gate line voltage V_{dm} are inverted between the frame to be scanned and the next frame.

Accordingly, since the first row pixels are scanned quickly after the frame switching, the influence by the leakage current is also light.

In a frame, the slower the scam timing is, the influence by the capacitive coupling and by the leakage current becomes greater. In positive and negative frames, in general, optical response waveforms thereof become asymmetric. One of the causes is that the OFF resistance of the TFT in the positive frame is different from that in the negative frame.

An optical response variation or change is perceived, in some times, as flicker. In particular, when a frame frequency is set to be lower than 60 Hz, the frequency of the flicker also becomes lower than 60 Hz and the flicker is easily perceived.

For this reason, it is necessary to make the optical response change sufficiently small. Explanation will now be directed to eye's sensitivity to the flicker. Flicker components having frequencies of about 60 Hz or higher are not detected. When consideration is paid to the fact that CRT displays data by emitting light on a pulse basis with a period of 60 Hz, it will be simply understood.

As the frame frequency is lower than 60 Hz nearly as a boundary, the eye's sensitivity to the flicker gradually increases, so that even a small luminance variation in a frame becomes perceived as flicker.

For flicker having a frequency of 15 Hz, when a value obtained by dividing a change in luminance between beginning and ending parts of a frame by an average luminance value of the frame is not smaller than about 0.03 or 0.04, it is experimentally known that the luminance change is perceived as flicker.

When a hold period having a length nearly equal to or longer than that of a scanning period is not provided in the aforementioned one frame, an optical response change takes place in most part of the one frame.

It is difficult to cause a user not to perceive the occurrence of the actual optical response change; by controlling the luminance of the backlight to sequentially compensate for the optical response change, considering a change in the liquid crystal voltage caused by the leakage current and the capacitive coupling, and further considering the liquid crystal response. This is because the magnitude of a variation in the liquid crystal voltage caused by the leakage current or the capacitive coupling depends on grayscale and the amplitude of the data line voltage.

The liquid crystal response also depends on the grayscale. For this reason, in a liquid crystal panel for displaying an image having a plurality of grayscales present therein, backlight control is required to be carried out in order to compensate for a luminance which varies in the entirety of one frame period. In order to control the aforementioned backlight control, a large scale of peripheral circuit is required.

When flicker is suppressed only by the driving method, it is hard to suppress flicker completely only by the driving method. For this reason, the storage capacitor may be made large to suppress flicker in pixel design. A problem is that, when the storage capacitor increases, an aperture ratio is reduced.

It is therefore an object of the present invention to provide a liquid-crystal display device which can display a high quality of picture and reduce its power consumption by suppressing flicker in a simple manner, while avoiding an increase in driver cost and avoiding increasing storage capacitor in pixel design, and also to provide a method for driving the liquid-crystal display.

In accordance with an aspect of the present invention, there is provided a method for driving a liquid-crystal display device. The liquid-crystal display device comprises a liquid crystal panel and a backlight unit. The liquid crystal panel includes a pair of substrates, a liquid crystal layer held between the pair of substrates, data and gate lines for applying an electric field to the liquid crystal layer, a plurality of active elements connected at intersections of the data and gate lines, and pixels driven by the active elements. The backlight unit is intermittently turned ON and OFF to intermittently irradiate the liquid crystal panel with light. In the method, a scanning period for providing image data from the data line to the pixels and a hold period for putting all of the gate lines in a non-scan state immediately after the scanning period are provided. The hold period has a length corresponding nearly to the scanning period or longer. A sum of the scanning period and the hold period corresponds to a frame period, the frame period is continuously repeated, the frame period is set to have a length not shorter than 1/60 seconds. A plurality of backlight periods each including an OFF period of the backlight unit and an ON period subsequent to the OFF period are provided. A sum of lengths of the plurality of backlight periods is equal to a length of the frame period. And the OFF period of the backlight unit is longer than the ON period of the backlight unit in the scanning period. As a result flicker can be suppressed.

In accordance with another aspect of the present invention, there is provided a method for driving a liquid-crystal display device. The liquid-crystal display device comprises a liquid crystal panel and a backlight unit. The liquid crystal panel includes a pair of substrates, a liquid crystal layer held between the pair of substrates, data and gate lines for applying an electric field to the liquid crystal layer, a plurality of active elements connected at intersections of the data and gate lines, and pixels driven by the active elements. The backlight unit is intermittently turned ON and OFF to intermittently irradiate the liquid crystal panel with light. In the method, a scanning period for providing image data from the data line to the pixels and a hold period for putting all of the gate lines in a non-scan state immediately after the scanning period are provided. The hold period has a length corresponding nearly to the scanning period or longer. A sum of the scanning period and the hold period corresponds to a frame period. The frame period is continuously repeated. The frame period is set to have a length not shorter than 1/60 seconds. A plurality of backlight periods each including an OFF period of the backlight unit and an ON period subsequent to the OFF period are provided. A sum of lengths of the plurality of backlight periods is equal to a length of the frame period. A period after scanning is started until nearly half of all the gate lines to be scanned is scanned is set to be a perceding half of the scanning period. A period until the remaining gate lines are scanned is set to be a succeeding half of the scanning period. At least the ON period of the backlight unit is set in the preceding half of the scanning period. At least the OFF period of the backlight unit is set in the succeeding half of the scanning period. As a result flicker can be suppressed.

In accordance with a further aspect of the present invention, there is provided a method for driving a liquid-crystal display device. The liquid-crystal display device comprises a liquid crystal panel and a backlight unit. The liquid crystal panel includes a pair of substrates, a liquid crystal layer held between the pair of substrates, data and gate lines for applying an electric field to the liquid crystal layer, a plurality of active elements connected at intersections of the data and gate lines, and pixels driven by the active elements. The backlight unit is intermittently turned ON and OFF to intermittently irradiate the liquid crystal panel with light, In the method, a scanning period for providing image data from the data line to the pixels and a hold period for putting all of the gate lines in a non-scan state immediately after the scanning period, are provided. The hold period has a length corresponding nearly to the scanning period or longer. A sum of the scanning period and the hold period corresponds to a frame period. The frame period is continuously repeated. The frame period is set to have a length not shorter than 1/60 seconds backlight periods each including an OFF period of the backlight unit and an ON period subsequent to the OFF period are continuously repeated. The backlight unit is turned ON and OFF at least once in the hold period. A period after scanning is started until nearly half of all the gate lines to be scanned is scanned is set to be a preceding half of the scanning period. A period until the remaining gate lines are scanned is set to be a succeeding half of the scanning period. At least the ON period of the backlight unit is set in the preceding half of the scanning period. At least the OFF period of the backlight unit is set in the succeeding half of the scanning period. As a result flicker can be suppressed.

In accordance with another aspect of the present invention, there is provided a method for driving a liquid-crystal display device. The liquid-crystal display device comprises a liquid crystal panel and a backlight unit. The liquid crystal panel includes a pair of substrates, a liquid crystal layer held between the pair of substrates, data and gate lines for applying an electric field to the liquid crystal layer, a plurality of active elements connected at intersections of the data and gate lines, and pixels driven by the active elements. The backlight unit is intermittently turned ON and OFF to intermittently irradiate the liquid crystal panel with light. In the method, a scanning period for providing image data from the data line to the pixels and a hold period for putting all of the gate lines in a non-scan state immediately after the scanning period, are provided. The hold period has a length corresponding nearly to the scanning period or longer. A sum of the scanning period and the hold period corresponds to a frame period. The frame period is continuously repeated. The frame period is set to have a length not shorter than 1/60 seconds. Backlight periods each including an OFF period of the backlight unit and an ON period subsequent to the OFF period are continuously repeated. The backlight unit is turned ON and OFF at least once in the hold period. A period after scanning is started until nearly half of all the gate lines to be scanned is scanned is set to be a preceding half of the scanning period. A period until the remaining gate lines are scanned is set to be a succeeding half of the scanning period. At least the ON period of the backlight unit is set in the preceding half of the scanning period. At least the OFF period of the backlight unit is set in the succeeding half of the scanning period. As a result flicker can be suppressed.

In accordance with a further aspect of the present invention, there is provided a liquid-crystal display device which comprises a liquid crystal panel and a backlight unit. The liquid crystal panel includes a pair of substrates, a liquid crystal layer held between the pair of substrates, data and gate lines for applying an electric field to the liquid crystal layer, a plurality of active elements connected at intersections of the data and gate lines, and pixels driven by the active elements. The backlight unit is intermittently turned ON and OFF to intermittently irradiate the liquid crystal panel with light. In the liquid-crystal display device, a light source of the backlight unit is a light emitting diode. A scanning period for providing image data from the data line to the pixels and a hold period for putting all of the gate lines in a non-scan state immediately after the scanning period, are provided. The hold period has a length corresponding nearly to the scanning period or longer. A sum of the scanning period and the hold period corresponds to a frame period. The frame period is continuously repeated. The frame period is set to have a length not shorter than 1/60 seconds. A plurality of backlight periods each including an OFF period of the backlight unit and an ON period subsequent to the OFF period, are provided. A sum of lengths of the plurality of backlight periods is equal to a length of the frame period. And the OFF period of the backlight unit is longer than the ON period of the backlight unit in the scanning period. As a result flicker can be suppressed.

In accordance with yet another aspect of the present invention, there is provided a liquid-crystal display device which comprises a liquid crystal panel and a backlight unit. The liquid crystal panel includes a pair of substrates, a liquid crystal layer held between the pair of substrates, data and gate lines for applying an electric field to the liquid crystal layer, a plurality of active elements connected at intersections of the data and gate lines, and pixels driven by the active elements. The backlight unit is intermittently turned ON and OFF to intermittently irradiate the liquid crystal panel with light. In the liquid-crystal display device, a light source of the backlight unit is a light emitting diode. A scanning period for providing image data from the data line to the pixels and a hold period for putting all of the gate lines in a non-scan state immediately after the scanning period, are provided. The hold period has a length corresponding nearly to the scanning period or longer. A sum of the scanning period and the hold period corresponds to a frame period. The frame period is continuously repeated, and the frame period is set to have a length not shorter than 1/60 seconds. A plurality of backlight periods each including an OFF period of the backlight unit and an ON period subsequent to the OFF period, are provided. A sum of lengths of the plurality of backlight periods is equal to a length of the frame period. A period after scanning is started until nearly half of all the gate lines to be scanned is scanned is set to be a preceding half of the scanning period. A period until the remaining gate lines are scanned is set to be a succeeding half of the scanning period. A control circuit for controlling timing of the backlight is provided so that at least the ON period of the backlight unit is set in the preceding half of the scanning period, and so that at least the OFF period of the backlight unit is set in the succeeding half of the scanning period. As a result flicker can be suppressed.

In accordance with a still further aspect of the present invention, there is provided a liquid-crystal display device which comprises a liquid crystal panel and a backlight unit. The liquid crystal panel includes a pair of substrates, a liquid crystal layer held between the pair of substrates, data and gate lines for applying an electric field to the liquid crystal layer, a plurality of active elements connected at intersections of the data and gate lines, and pixels driven by the active elements. The backlight unit is intermittently turned ON and OFF to intermittently irradiate the liquid crystal panel with light. In the liquid-crystal display device, a scanning period for providing image data from the data line to the pixels and a hold period for putting all of the gate lines in a non-scan state immediately after the scanning period, are provided. The hold period has a length corresponding nearly to the scanning period or longer. A sum of the scanning period and the hold period corresponds to a frame period. The frame period is continuously repeated. The frame period is set to have a length not shorter than 1/60 seconds. A dynamic range of a voltage to be applied to the data line can be adjusted. The dynamic range is made narrow in an arbitrary frame and simultaneously the quantity of backlight in one frame is made small. As a result flicker can be suppressed.

In accordance with an additional aspect of the present invention, there is provided a liquid-crystal display device and a method for driving the liquid-crystal display device. The liquid-crystal display device comprises a liquid crystal panel and a backlight unit. The liquid crystal panel includes a pair of substrates, a liquid crystal layer held between the pair of substrates, data and gate lines for applying an electric field to the liquid crystal layer, a plurality of active elements connected at intersections of the data and gate lines, and pixels driven by the active elements. The backlight unit is intermittently turned ON and OFF to intermittently irradiate the liquid crystal panel with light. In this aspect, a plurality of backlight periods each having an OFF period of the backlight unit and an ON period subsequent to the OFF period are set in the frame period in synchronism with a frame period. The frame period has a scanning period for providing image data from the data line to the pixels and also has a hold period for putting all of the gate lines in a non-scan state immediately after the scanning period. The hold period has a length longer than the scanning period. And the backlight unit is intermittently driven in the plurality of backlight periods. As a result flicker can be suppressed.

The present invention is not limited to the arrangements and embodiments (to be explained later) set forth in Claims, but may be modified in various ways without departing from the technical idea of the present invention, as a matter of course.

In accordance with the present invention, the liquid-crystal display device can advantageously suppress flicker and reduce power while securing a good quality of image.

Other objects, features and advantages of the invention will become apparent from the following description of the embodiments of the invention taken in conjunction with the accompanying drawings.

### BRIEF DESCRIPTION OF THE DRAWINGS

FIGS. 1A and 1B show a timing chart for explaining a driving method in accordance with an Embodiment 1 of the present invention;

FIG. 2 shows optical response waveforms to flicker used to explain Embodiment 1;

FIGS. 3A and 3B show a timing chart for explaining a driving method in accordance with an embodiment 2 of the present invention;

FIGS. 4A, 4B, 4C, and 4D show a timing chart for explaining a driving method in accordance with an embodiment 3 of the present invention;

FIGS. 5A and 5B show a timing chart for explaining a driving method in accordance with an embodiment 4 of the present invention;

FIGS. 6A, 6B, and 6C show a timing chart for explaining a driving method in accordance with an embodiment 5 of the present invention;

FIG. 7 is a diagram for explaining a liquid-crystal display device in accordance with an embodiment of the present invention;

FIG. 8A is a diagram for explaining a liquid-crystal display device in accordance with another embodiment of the present invention;

FIG. 8B is a timing chart for explaining the operation of the liquid-crystal display device of FIG. 8A;

FIG. 9 is a diagram for explaining a liquid-crystal display device in accordance with a further embodiment of the present invention;

FIG. 10A is a timing chart for explaining an example of controlling operation of the liquid-crystal display device of the present invention;

FIG. 10B is a timing chart for explaining another example of controlling operation of the liquid-crystal display device of the present invention;

FIG. 11A is a diagram for explaining image data sent to a CPU and a liquid-crystal display device;

FIG. 11B shows a circuit for generating a grayscale voltage;

FIG. 11C shows another circuit for generating a grayscale voltage;

FIG. 12A is a block diagram of a prior art liquid-crystal display device;

FIG. 12B shows an equivalent circuit of pixels arranged in n rows and in m columns; and

FIG. 12C is a diagram for explaining a schematic diagram of driving method.

### DETAILED DESCRIPTION OF THE EMBODIMENTS

Embodiments of the present invention will be explained by referring to drawings.

### Embodiment 1

Explanation will be made as to an embodiment 1. Generally speaking, in a liquid-crystal display device, an optical response waveform when a hold period having a length nearly equal to or longer than that of a scanning period is provided is different from an optical response waveform when such a hold period is not provided. It is already known experimentally that, in the case of provision of such a hold period, an optical response change takes place in a scanning period, luminance becomes nearly constant in the hold period with time, or the optical response change takes place slowly.

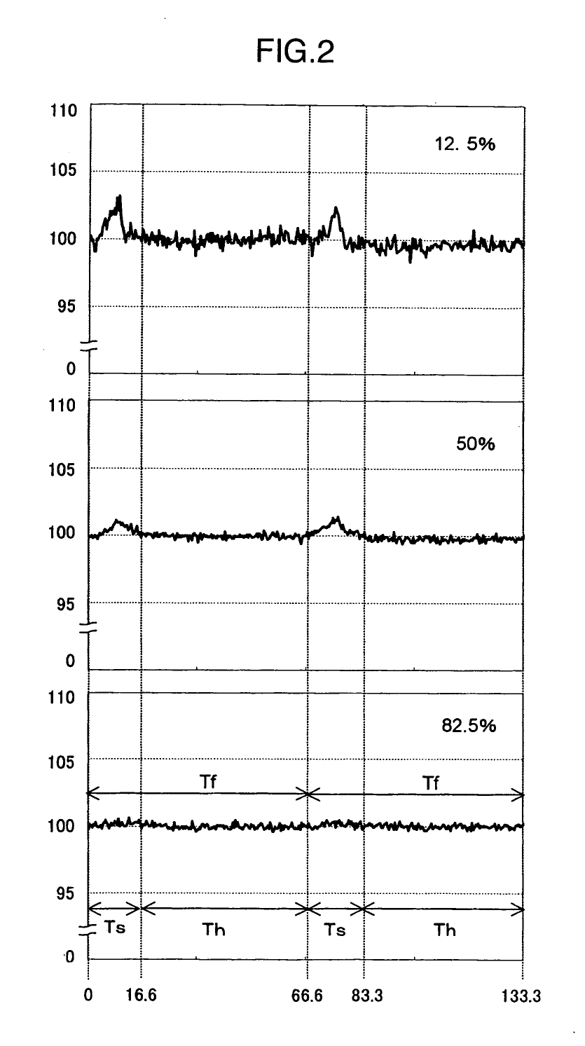

Its experimental result is shown in FIG. 2. The luminance of backlight is constant. In the experiment, a scanning period Ts is nearly 16.6 ms (≈ 1/60 seconds), and a hold period Th is about 50 ms. A frame period Tf is about 66.6 ms (≈ 1/15 seconds). That is, the frame period is longer than 1/60 seconds and shorter than 1 second.

In the drawing, an uppermost-stage graph shows an optical response waveform when a relative luminance is 12.5%. The “relative luminance” refers to a relative luminance between the maximum luminance of 100% displayable by a liquid crystal panel and the lowest luminance of 0% thereby. A middle-stage graph shows an optical response waveform when the relative luminance is 50% and, and a lowermost-stage graph shows an optical response waveform when the relative luminance is 82.5%.

In the graphs, abscissa denotes time (ms), and ordinate denotes normalized luminance (%) when a luminance at each time is normalized with an average of luminance values of a frame. Measurement is carried out at the central part of a liquid crystal panel when a display system is a normally open mode. Accordingly, pixels in the vicinity pixels nearly in the N/2-th row are measured.

Pixels in a measurement part are scanned at a time of passage of about 8.3 ms after frame start. It will be observed in any of the graphs that an optical response change in the hold period Th is nearly zero and the luminance is constant. It is observed in the scanning period Ts that, as the relative luminance decreases, the optical response change is increased.

In the optical response change occurred in the scanning period Ts, any luminance once increases, becomes maximum nearly at a scan time. And even when the response is slow, the luminance becomes the first luminance in the scanning period Ts before the former half of the hold period Th.

The above luminance increase is due to a change in a liquid crystal voltage by capacitive coupling generated by polarity inversion upon frame switching and a change in a liquid crystal voltage by an increase in a large current between data line and pixel electrode because a voltage between the data line and the pixel electrode is larger than that before the polarity inversion.

The luminance in the hold period Th is constant. The reasons are as follows. Because voltages on the wiring lines are constant, the capacitive coupling causes no variation of the liquid crystal voltage. And since the voltage difference between the wiring line and the present embodiment is nearly smaller than the amplitude of the gate line voltage, the leakage current is small.

Accordingly, when a hold period is provided, the luminance in the hold period is constant or the optical response change is slow. And since the optical response change takes place in the scanning period, it is only required to suppress the optical response change in the scanning period.

Explanation will now be made as to the power of the liquid-crystal display device. The power of the liquid-crystal display device is divided into three sorts of power, that is, (1) operational power proportional to an operational frequency and including power of a logic circuit and power involved by charging/discharging operation of the liquid crystal panel regarded as a capacitance, (2) stationary power constantly consumed by an analog circuit or the like, and (3) power of a backlight unit. An object in the present embodiment is to reduce the operational power relating to driving of the liquid crystal panel and the stationary power.

In the case of no provision of the hold period, even when the frame frequency is reduced, only the operational power can be reduced. In the case of provision of the hold period, since the holding operation of image data is carried out in the hold period, it is possible to stop an analog circuit not associated with the holding operation.

Thus, when the hold period is provided, both of the operational power and the stationary power can be reduced by reducing the frame frequency. Further, since an existing liquid-crystal display device cannot reduce flicker having a low frequency, the display device is driven at a frame frequency of 60 Hz or higher.

When the frame frequency is set at 60 Hz, the scanning period is at 8.3 ms, and the hold period is at 8.3 ms for example; the stationary power can be reduced by stopping the analog circuit in the hold period. However, because the frame frequency is 60 Hz, the operational frequency of the logic circuit or the like per unit time is the same as that when the hold period is not provided, and thus the operational power cannot be reduced.

In order to effectively reduce both of the stationary power and the operational power, it is necessary to make the frame frequency lower than 60 Hz. For example, when the display device is driven with a scanning period of 16.6 ms and a hold period of 50 ms, a total of the stationary power and the operational power can be reduced to about ¼ (≈16.6/(16.6+50)) of that when the display device is driven with a frame frequency of 60 Hz.

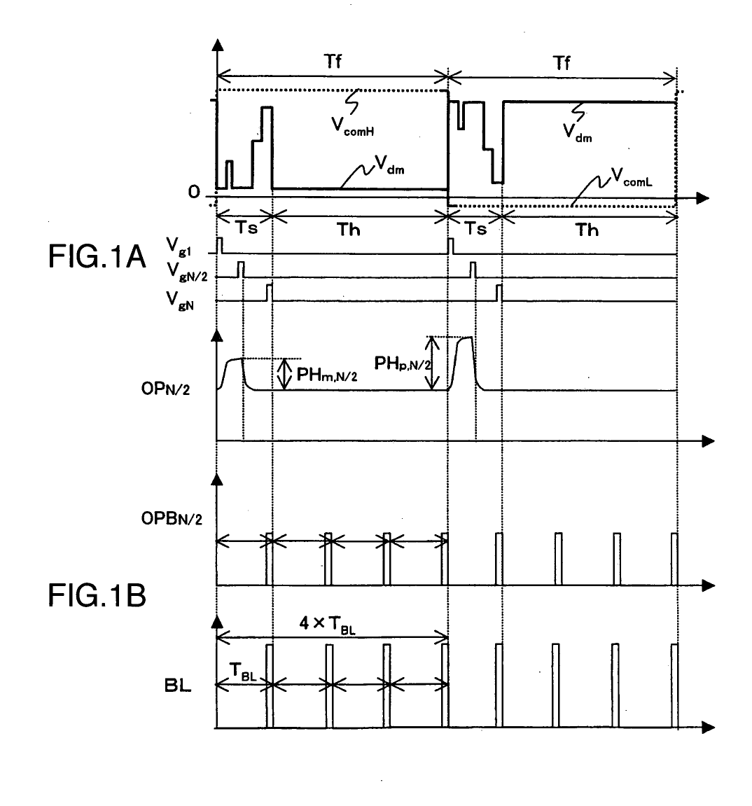

FIGS. 1A and 1B show a schematic diagram of driving method corresponding to two continuous frames of drive by common electrode AC frame inversion driving method, an optical response OP_{N/2} of pixels in an N/2-th row when the luminance of backlight is constant with time, and an optical response OPB_{N/2} of the pixels when the backlight is turned ON and OFF at timing shown as “BL”. In the drawing, reference symbols V_{gl}, V_{gN/2}, and V_{gN} denote voltages on the first, N/2-th, and N-th gate lines, and their variations in the voltages are also schematically shown.

In the frame period Tf, a scanning period is denoted by Ts, and the hold period Th denotes a time interval during which all the gate lines are in their non-scan state. Explanation will be made in connection with an example when the scanning period Ts is about 16.6 ms (≈⅙ seconds) and the hold period Th is about 50 ms. At this time, the frame frequency Tf is about 66.6 ms (≈ 1/15 seconds). Further, the display system of the liquid crystal is a normally open mode wherein white is displayed on the display when the liquid crystal voltage is zero.

In the frame period Tf, the voltage of the common electrode takes V_{comH} or V_{comL}. It is assumed that the frame when the common electrode voltage is at V_{comL} is positive and the frame when the common electrode voltage is at V_{comH} is negative.

The polarity of the liquid crystal voltage for the positive frame is written to become positive at desired timing in the scanning period Ts. Similarly, the liquid crystal voltage polarity for the negative frame is written to become negative at desired timing in the scanning period. The positive and negative frames are alternately repeated.

Accordingly, when image data is not changed in a still image or in two or more frames, the driving of the gate line and the driving of the common electrode are repeated for every two frames. This results in that the optical response waveform is also repeated for every two frames.

In the optical response OP_{N/2} in FIG. 1A, optical response waveforms in the positive and negative frames are nearly the same and constant with time in any hold period Th. In the scanning period Ts, the optical response waveforms are pulsative in the both frames. In general, however, pulse heights PH_{P,N/2} and PH_{m,N/2} may be different from each other.

Since the frame period Tf is about 1/15 seconds, main flicker components have frequencies of 15 Hz and 7.5 Hz. When the pulse heights PH_{P,N/2} and PH_{m,N/2} are nearly the same, the period of flicker to be perceived corresponds to the frame period Tf (flicker having a frequency of 15 Hz). When the pulse heights PH_{P,N/2} and PH_{m,N/2} are largely different from each other, the period of flicker to be perceived corresponds twice of the frame period Tf (flicker having a frequency of 7.5 Hz).

The backlight control in the present embodiment will be explained. Symbol BL shown in FIG. 1B denotes a time variation in the backlight luminance. Ordinate denotes luminance, and abscissa denotes time. A period including a period during which the backlight unit is turned ON and a subsequent period during which the backlight unit is turned ON, is denoted by a BL period T_{BL}.

The length of the BL period is equal to that of the scanning period Ts of 16.6 ms. Each of most BL periods us nearly equal to the scanning period and corresponds to ¼ of the frame period. Accordingly, the backlight is turned ON four times in the frame period Tf, and its turn-ON frequency is about 60 Hz.

In the BL period which is positioned at the beginning part of the frame period Tf and occupies a major part of the scanning period Ts, backlight is controlled so that, in the optical response OP_{N/2} in the scanning period Ts, backlight is turned OFF in a period when flicker becomes the largest. This is because flicker is made invisible by turning OFF the backlight. At this time, in the scanning period Ts, a backlight turning-OFF part is longer than a backlight turning-ON part.

When backlight is controlled in this way, the optical response waveform of the liquid crystal panel is repeated with a length of the BL period of 16.6 ms (≈ 1/60), as shown by OPB_{N/2}.

Since the optical response waveform repeated at a frequency of about 60 Hz or higher can be seen to user's eye with a constant time-averaged luminance at a repetition frequency on a display device having a front luminance of at least 1,000 cd/m² or lower, it cannot be seen as flicker.

In other words, when backlight is not controlled, flicker occurred at a frequency of 15 Hz or lower is made imperceptive to the user by controlling the backlight to convert it to flicker of 60 Hz.

Flicker is made imperceptive not only by making a backlight turning-OFF part longer than a backlight turning-ON part in the scanning period Ts to remove flicker in the scanning period Ts shown in the optical response variation OP_{N/2}, but also by turning ON/OFF the backlight even in the hold period Th to convert the optical response waveform to a waveform repeated at a frequency of 60 Hz. In particular, if the backlight is not turned OFF in synchronism with the timing of increased flicker in the scanning period, then it becomes difficult to suppress 15 Hz flicker. For this reason, the scanning period is overlapped with a single BL period in the present embodiment. As will be explained in an embodiment 2, the number of the BL periods overlapped with the scanning period is not always limited to 1, but it may, in some cases, be 2 or 3 in accordance with a relation in timing of transmitting the image data to the liquid crystal and driving the backlight.

When four continuous BL periods are combined into a single period and the single period is defined as a BL frame period for simplicity, a BL frame is synchronized with a frame by making the length of the combined BL frame period equal to the frame period Tf. This is for the purpose of preventing flicker of a low frequency from generating when the BL frame period is not synchronized with the frame period Tf, because flicker of 15 Hz cannot be accurately converted to flicker of 60 Hz.

In the present embodiment, the length of the BL period has been set at 16.6 ms. However, the BL period length may be set at 1/60 seconds or smaller. In this example, the length of the BL period has been set at 1/60 seconds or smaller based on the fact that the optical response change repeated at a frequency of 60 Hz or higher cannot be perceived as flicker. However, an imperceptive boundary frequency of flicker is about 60 Hz, so that, even when a flicker frequency is lower than 60 Hz by several Hz, that is, 59 Hz or 58 Hz; the flicker may be made, in some cases, imperceptive.

Though all the BL periods have been set to have an equal length in the present embodiment, the present invention is not limited to the BL periods of an equal length. For example, four BL periods of 16.8 ms, 16.7 ms, 16.6 ms and 16.5 ms may be combined into a single frame period of 66.6 ms as a total of the above BL period lengths. It is only required that the lengths of the BL periods be each about 1/60 seconds or lower and the total length thereof be equal to the frame period of 66.6 ms.

In general, the pulse height of an optical response waveform in a scanning period depends on positive and negative frames and grayscale. With the arrangement of the present invention, however, since backlight is turned OFF during generation of such pulse, flicker can be suppressed independently of the pulse height.

In the present embodiment, the driving of the gate line and the driving of the common electrode have been inverted for each common AC frame. However, even when different driving methods are employed for inversion for each column, inversion for each line, dot inversion, and scan and hold periods; the method for controlling backlight explained in the present embodiment can effectively suppress flicker.

In the case of the driving method for providing a hold period having a length nearly equal to or longer than that of the scanning period, image data is only held in the hold period. Thus, the optical response change in the hold period is slow or is not present, and the optical response change takes place mainly in the scanning period. Accordingly, when the hold period is provided, the method for controlling backlight explained in the present embodiment can suppress flicker.

### Embodiment 2

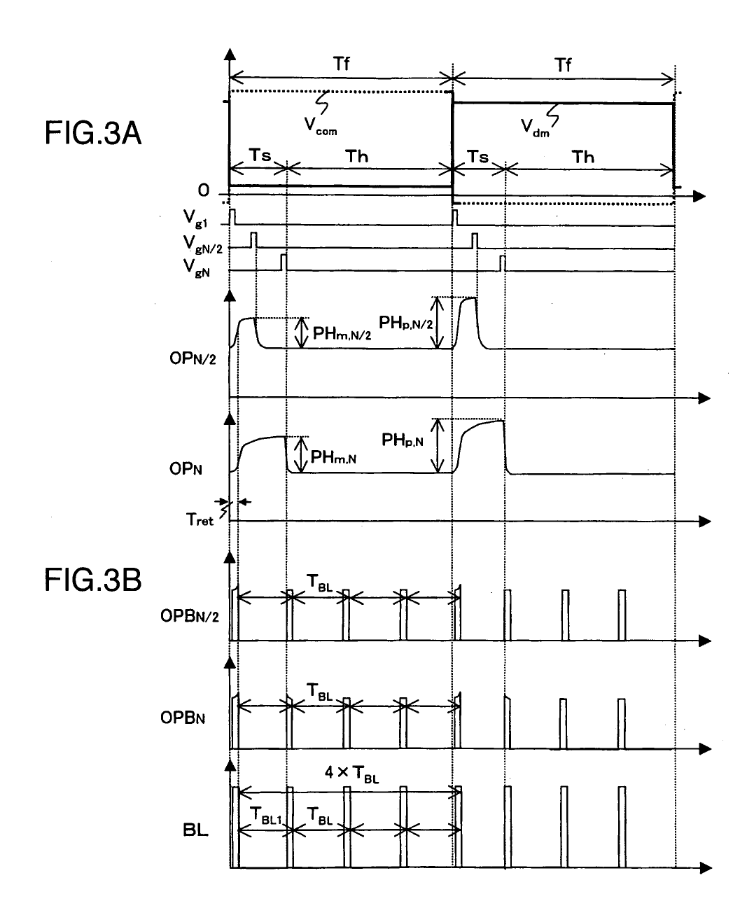

Explanation will be made as to an embodiment 2 of the present invention with reference to FIG. 3. In the drawing, parts having the same reference symbols as those in the embodiment 1 denote the same parts as explained in the embodiment 1.

FIGS. 3A and 3B show a schematic diagram of driving method corresponding to two continuous frames, optical responses OP_{N/2} and OP_{N} to pixels in N/2-th and N-th rows when the luminance of backlight is constant with time, and optical responses OPB_{N/2} and OPB_{N} to the pixels when the backlight is turned ON and OFF at timing of the BL period.

Symbols V_{gl}, V_{gN/2}, and V_{gN} denote voltages on the first, N/2-th, and N-th gate lines, and time variations thereof are also schematically shown. In the frame period Tf, the scanning period is denoted by Ts. In the hold period Th of the frame period, all gate lines are in the non-scan state. Explanation will now be made in connection with an example wherein the scanning period Ts has a length of about 16.6 ms (≈ 1/60 seconds) and the hold period Th has a length of about 50 ms.

In this case, the frame period Tf has a length of about 66.6 ms (≈ 1/15 seconds). The liquid crystal display system is a normally open mode wherein, when a liquid crystal voltage is zero, white is displayed, and image data for a low relative luminance is given to all the pixels of the liquid crystal panel.

In optical responses OP_{N/2} and OP_{N} shown in FIG. 3, optical response waveforms in positive and negative frames are nearly the same and constant with time in any hold period Th. In the scanning periods Ts of the two frames, the optical response waveforms are pulsative.

Since pixels in the N-th row are longer than pixels in the N/2-th row in a length until scanned from the start of the scanning period, the optical response change continues over the entire scanning period. For this reason, a pulse height PH_{P,N} is larger than a pulse height PH_{P,N/2} and a pulse height PH_{m,N} is larger than a pulse height PH_{m,N/2}.

Explanation will now be made as to a relation between the pulse height and the relative luminance. It is already known that, as shown in FIG. 2, in grayscale having relative luminance of from about 10% to 100%, the higher the liquid crystal voltage is (the lower the relative luminance is due to the normally open mode) the larger the pulse height occurred in the scanning period is. In range of relative luminance from 0% to 10%, the aforementioned relation may be inverted because the luminance of the liquid crystal panel depends on non-linear voltage.

Therefore, when the relative luminance is not smaller than 10% and image data to be given to pixels correspond to high relative luminance, flicker to be perceived can less take place. When the image data correspond to low relative luminance, however, flicker to be perceived can easily take place.

In other words, when image data to be given to pixels is compatible with high relative luminance, the need for performing backlight control to suppress pixel flicker can be eliminated. Whereas, when image data to be given to pixels is compatible with low relative luminance, backlight control is required to suppress pixel flicker.

When image data compatible with low relative luminance is given to pixels in the vicinity of the N-th row and when the scanning period is set at 1/60 seconds that is the same as an existing frame period, the BL period cannot be set to be longer than about 16.6 ms (that is, the BL period has an available maximum length of about 1/60 seconds), due to a frequency characteristic of human-eye sensitivity to optical response change. It is difficult to control the liquid crystal panel in such a manner as to turn OFF backlight in all periods where a luminance in the scanning period Ts is larger than a luminance in the hold period Th by about the pulse height PH_{P,N} or PH_{m,N}, as shown by the optical response waveform OP_{N}.

A liquid crystal voltage variation causing a pulsative optical response change takes place at the beginning of the scanning period. However, due to the liquid crystal response, it takes several milliseconds in the scanning period before it reaches a luminance level (larger than the luminance of the hold period by half of the pulse height PH_{P,N}) causing a flicker problem. A time period from the start of the scanning period to the arrival at such a luminance level as to cause a flicker problem is defined as a delay period Tᵣₑₜ.

In view of the delay period Tᵣₑₜ, flicker can be suppressed by controlling backlight.

Explanation will be made as to backlight control shown as BL in FIG. 3. The BL period has a length of about 16.6 ms that is nearly the same as the scanning period Ts, and all the BL periods have an equal length corresponding to ¼ of the frame period Tf. Accordingly, backlight is turned ON four times within the frame period Tf and its turn-ON frequency is about 60 Hz.

When the start of the BL period is defined by a time point when backlight is changed from ON to OFF, the start point of the scanning period Ts is shifted from the start point of the BL period. That is, the start point of the BL period is started with a delay of the delay period Tᵣₑₜ with respect to the start point of the scanning period Ts. In this connection, the BL period started first after the start of the scanning period will be referred to as the first BL period T_{BL1}. In the present embodiment, the first BL period T_{BL1} is started with a delay of the delay period Tᵣₑₜ.

The panel is controlled so that backlight is turned OFF in a part of the first BL period causing the luminance to form a flicker problem. At this time, in the scanning period Ts, a backlight turning-OFF part is longer than a backlight turning-ON part. In this case, the number of the BL periods overlapped with the scanning period is 2. The number of the BL periods overlapped with the scanning period may be 3 depending on the start timing of the first BL period and the length of the BL period. When the number of the BL periods overlapped with the scanning period is set at 4 or larger and the BL periods are set to have an equal length, the backlight is required to be turned ON at the timing of increased flicker in the scanning period. To avoid this, it is desirable that the number of the BL periods overlapped with the scanning period be 3 or smaller.

Since backlight is controlled in this way, as shown by the optical responses OPB_{N/2} and OPB_{N} in FIG. 3, the pulsative optical response waveform in the scanning period Ts can be made substantially invisible. And by setting the repetition period of the optical response waveform at 1/60 seconds, a picture quality without flicker can be obtained.

The start point of the scanning period Ts is shifted from the start point of the BL period and the delay period Tᵣₑₜ has a length of several ms. Therefore, when the scanning period Ts has a length of about 16.6 ms, a time point, at which the light of the backlight unit is changed from ON to OFF first after the start of the scanning period, is present in the former half of the scanning period Ts, as shown by BL in FIG. 3.

The former half and latter half of the scanning period as used therein have following meanings. Assuming reference symbol N1 (an integer being 1 or more) denotes the number of all gate lines to be scanned (referred to as the total gate number), the former half of the scanning period is a period from scanning start until nearly half (N½ when N1 is an even number, or (N1−1)/2 when N1 is an odd number) of the total gate line number N1 is scanned. While, the later half of the scanning period is a period from scanning start until the remaining lines are scanned.

### Embodiment 3

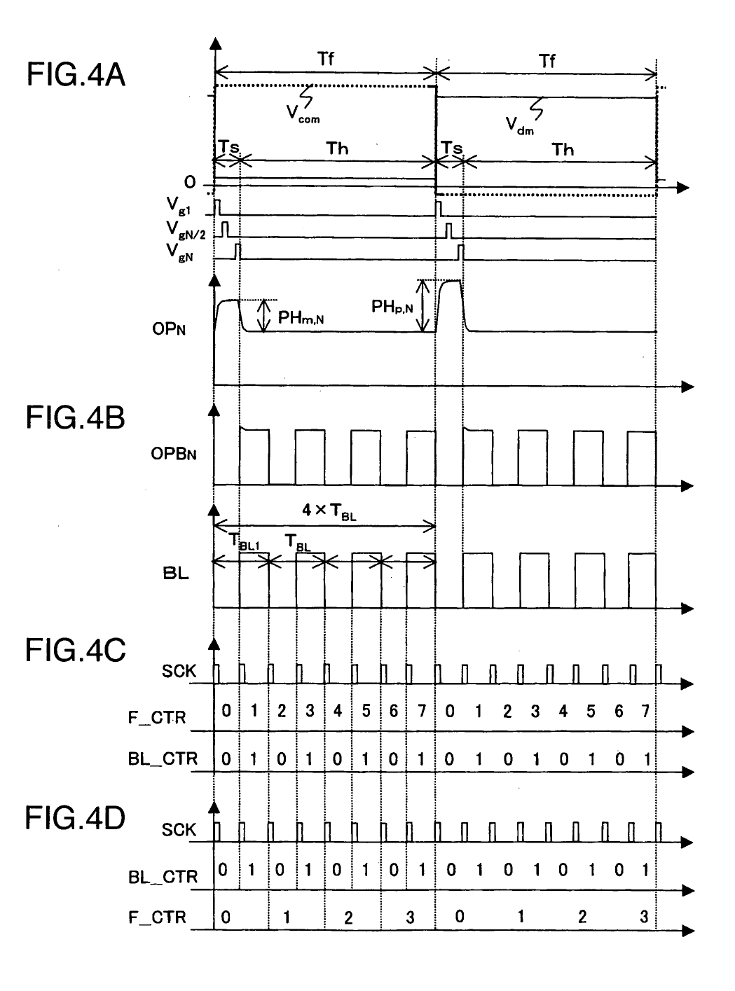

An embodiment 3 of the present invention will be explained by referring to FIG. 4. In the drawing, parts having the same reference symbols as those in the embodiments 1 and 2 denote the same parts as explained in the embodiments 1 and 2.

FIGS. 4A, 4B, 4C, and 4D show a schematic diagram of driving method corresponding to two continuous frames, an optical response OP_{N} to pixels in the N-th row when the luminance of backlight is constant with time, and an optical response OPB_{N} to the pixels when the backlight is turned ON and OFF at timing of a BL period. Reference symbols V_{gl}, V_{gN/2}, and V_{gN} denote voltages on the first, N/2-th, and N-th gate lines, and their time variations are also schematically shown.

In the frame period Tf, scanning is carried out in the scanning period Ts, and all the gate lines are in their non-scan state in the hold period Th.

Explanation will be made in connection with an example wherein the scanning period Ts is about 8.3 ms (≈ 1/120 seconds) and the hold period Th is about 58.3 ms. In this case, the frame period Tf is about 66.6 ms (≈ 1/15 seconds).

It is also assumed in the example that the liquid crystal display system is a normally open mode wherein white is displayed when a liquid crystal voltage is zero, and that image data compatible with low relative luminance is given to all pixels of a liquid crystal panel.

Backlight control shown by BL in FIG. 4B will be explained. The length of the BL period is about 1/60 seconds, and all the BL periods have each an equal length corresponding to ¼ the length of the frame period Tf.

Accordingly, backlight is turned ON four times in the frame period Tf, and its turn-ON frequency is about 60 Hz. Backlight is in the OFF state through the entire scanning period in the first BL period T_{BL1}.

When backlight is controlled in this way, as shown by OPB_{N} in FIG. 4, a pulsative optical response waveform in the scanning period Ts can be made substantially invisible. And when the repetition period of the optical response waveform is set at 1/60 seconds, a picture quality without flicker can be obtained.

Our attention is directed to the fact that, when the repetition period of the optical response waveform is set to be longer than about 1/60 seconds, the optical response waveform can be perceived as flicker, and that the width of a pulse in the scanning period Ts becomes nearly equal to the length of the scanning period Ts or somewhat longer than the length of the scanning period. Based on the above fact, by setting the scanning period to be shorter than 1/60 seconds and setting the length of the BL period at about 1/60 seconds, backlight can be put in the OFF state through the entire scanning period wherein pulsative flicker occurs.

In one BL period, a ratio of an ON period to the BL period (referred to as the ON ratio, hereinafter) can be made large. For example, when the luminance of the backlight in the ON period is made constant with respect to the luminance of the liquid crystal panel having an ON ratio of 100%, that is, when the ON ratio is set at 50%; the luminance of the liquid crystal panel becomes half.

In order to make the luminance of the liquid crystal panel having an ON ratio of 100% equal to the luminance of the liquid crystal panel having an ON ratio of 50%, it is required to double the luminance of the backlight at the time of the ON ratio of 50%. However, since the ON ratio is 50% even when the luminance of the backlight is made double, a power for an ON ratio of 100% is the same as that for an ON ratio of 50%.

When the ON ratio is set at about 10%, however, it is required to provide a high output of backlight in order to increase the luminance of the backlight by 10 times.

When the length of the scanning period is set shorter than 1/60 seconds and the length of the BL period is set at 1/60 seconds as in the present embodiment, the need for making the ON ratio extremely small can be eliminated.

It is not desirable to put the backlight in the ON state during the scanning period, and it is preferable to make the ON ratio larger than 10% (1.66 ms) though the ON period of the backlight. Thus it is desirable to make the scanning period shorter than about 15 ms (≈16.66 ms−1.66 ms). For example, when the scanning period is set at 12.5 ms ( 1/80 seconds), an ON period can be set at 4.1 ms and an ON ratio can be set at about 25% with respect to the BL period of 16.6 ms.

By shifting the start point of the scanning period Ts from the start point of the BL period, starting the start point of the BL period with a delay of the delay period Tᵣₑₜ with respect to the scanning period, and making the scanning period shorter than 1/60 seconds; an ON ratio can be made high. For example, when the scanning period is 12.5 ms ( 1/80 seconds) and the delay period Tᵣₑₜ is 2.5 ms; an OFF period can have a length of 10 ms, an ON period can have a length of 6.6 ms, and an ON ratio can have a value of about 40% with respect to the BL period of 16.6 ms.

When the scanning period is set at 10 ms ( 1/100 seconds) and the delay period Tᵣₑₜ is at 2.5 ms; an OFF period can be set at 7.5 ms, an ON period can be set at 9.1 Ms, and an ON ratio can be set at about 55% with respect to the BL period of 16.6 ms.

In the present embodiment, the scanning period Ts is set at 8.3 ms ( 1/120 seconds) and the hold period Th is set at 58.3 ms that is about seven times the scanning period. Further, the BL period is set at 16.6 ms that is about double of the scanning period. Since the length of each period is set with respect to the length of the scanning period Ts as a reference, flicker suppression based on the backlight control can be easily realized.

A driving sequence is shown in FIG. 4C. A pulse SCK generated for each scanning period Ts is used as a clock signal, and two counters F−CTR and BL−CTR for counting the number of such pulses are provided. By counting the number of pulses, the length of the BL period and the length of the hold period can be prescribed.

The counter F_CTR repeats a value in a range from 0 to 7, and the counter BL_CTR alternately repeats 0 and 1. Each counter increments its value by 1 for each clock signal SCK.

When the start time of the frame period Tf and the start time of the BL period are set at the changing time of the value of the counter F_CTR from 7 to 0 and the changing time of the value of the counter BL_CTR from 1 to 0 respectively, the hold period Th can be set at 58.3 ms that is about seven times the scanning period Ts and the BL period can be set at 16.6 ms that is about twice of the scanning period Ts.

In the present embodiment, the BL period is about twice of the scanning period Ts and the frame period Tf has a length corresponding to 4 times the BL period.

In this way, when the BL period is set at n times (n being an integer of 1 or larger) the scanning period Ts and the frame period Tf is set at m times (m being an integer of 1 or larger) the BL period, flicker suppression based on the backlight control can be easily realized by carrying out such a driving sequence as shown in FIG. 4D.

A pulse SCK generated for each scanning period is used as a clock signal. And a counter BL_CTR for counting the number of such pulses and a counter F_CTR for incrementing its value when the value of the counter BL_CTR is changed from 1 to 0, are provided. Thus, the length of the BL period and the length of the frame period can be prescribed.

The counter BL_CTR alternately repeats 0 and 1 for each clock signal SCK. The counter F_CTR repeats a value in a range from 0 to 3, and increments by 1 when the value of the counter BL_CTR is changed from 1 to 0.

When the start time of the frame period Tf and the start time of the BL period are set at the changing time of the value of the counter F_CTR from 3 to 0 and the changing time of the value of the counter BL_CTR from 1 to 0 respectively, the BL period can be set at 16.6 ms that is about double of the scanning period Ts and the frame period Tf can be set at 66.6 ms that is about four times the BL period.

In this connection, as the clock signal SCK, any of signals supplied from an external device located outside the liquid-crystal display device may be used, or the clock signal may be generated inside the display device.

### Embodiment 4

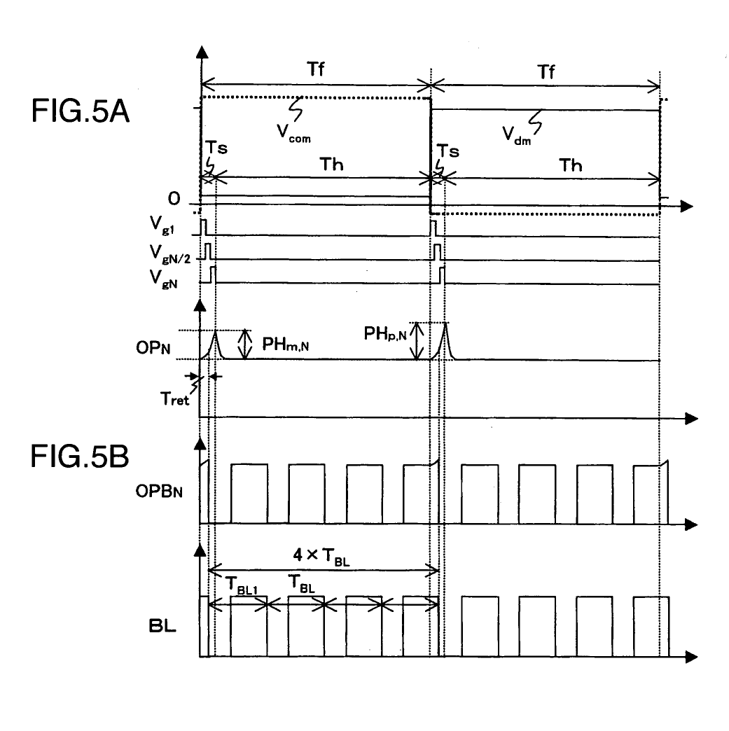

An embodiment 4 of the present invention will be explained with reference to FIG. 5. In the drawing, parts having the same reference symbols as those in the embodiments 1 to 3 denote the same parts as explained in the embodiments 1 to 3.

FIGS. 5A and 5B show a schematic diagram of driving method corresponding to continuous two frames, an optical response OP_{N} of pixels in an N-th row when the luminance of backlight is made constant with time, and an optical response OPBN of the pixels in the N-th row when the backlight is turned ON and OFF at timing of BL in the drawing. Reference symbols V_{gl}, V_{gN/2}, and V_{gN} denote voltages on gate lines of the first, N/2-th, and N-th rows, and their time variations are also schematically shown. In the scanning period Ts within the frame period Tf, scanning is carried out. In the hold period Th within the frame period Tf, all gate lines are put in a non-scan state.

Explanation will be made in connection with an example wherein the scanning period Ts is set at about 4.15 ms (≈ 1/240 seconds) and the hold period Th is set at about 62.45 ms. At this time, the frame period Tf is set at about 66.6 ms (≈ 1/15 seconds).

Further, the liquid crystal display system is a normally open mode wherein white is displayed when a liquid crystal voltage is zero, and image data compatible with low relative luminance is given to all pixels of a liquid crystal panel.

FIGS. 5A and 5B show how to control backlight shown by BL. The length of the BL period is about 1/60 seconds, and all the BL periods have each an equal length that corresponds to ¼ of the frame period Tf. Accordingly, backlight is turned ON four times in the frame period Tf, and its turn-ON frequency is about 60 Hz.

The start time of the scanning period Ts is shifted from the start time of the BL period, and the BL period is started with a delay of the delay period Tᵣₑₜ with respect to the start time of the scanning period Ts. The BL period is referred to as the first BL period T_{BL1}.

Considering liquid crystal response, the delay period Tᵣₑₜ becomes a value between about 2 ms and 4 ms. In the present embodiment, since the scanning period Ts is 4.15 ms (≈ 1/240 seconds), the first BL period T_{BL1} may be started in the latter half of the scanning period Ts. In the present embodiment, the first BL period T_{BL1} is started from 2.5 ms.

The luminance varies from the start time of the scanning period Ts with the liquid crystal response, and luminance as a flicker problem takes place in a duration from the latter half of the scanning period Ts to the former half of the hold period.

Accordingly, in the first BL period T_{BL1} overlapped between the latter half of the scanning period Ts and the former half of the hold period Th, the panel is controlled so that the backlight is in an OFF state during the period wherein the luminance causes the flicker problem.

In this case, in the scanning period Ts, a backlight OFF period is shorter than a backlight ON period, but a backlight OFF period is provided at least in the latter half of the scanning period Ts.

When such backlight control is carried out in this way, a pulsative optical response waveform in the first BL period T_{BL1} can be made substantially invisible, as shown by OPB_{N} in FIG. 5. And by setting the repetition period of the optical response waveform is set at 1/60 seconds, a picture quality without flicker can be obtained.

Although the display mode of the liquid crystal panel has employed the normally open mode in the embodiments 1 to 4, the display mode is not limited to the specific example, but may employ a normally close mode. Even in the latter case, the backlight control method explained in the embodiments 1 to 4 can effectively suppress flicker.

### Embodiment 5

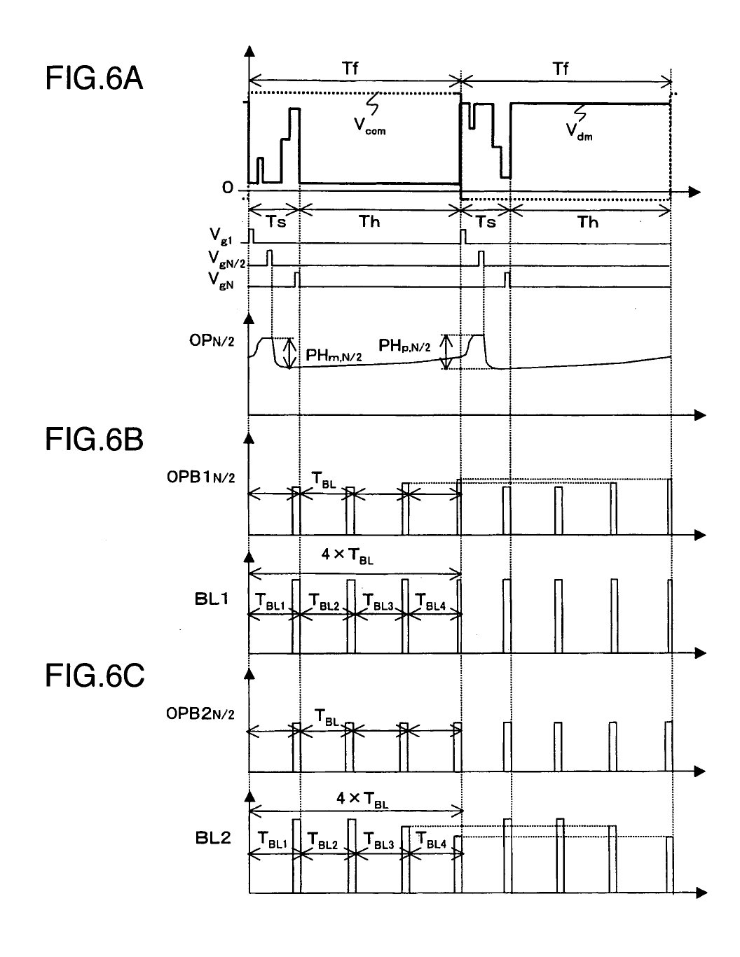

Explanation will be made as to an embodiment by referring to FIG. 6. In the drawing, parts having the same reference symbols as those in the embodiments 1 to 4 denote the same parts as explained in the embodiments 1 to 4.

FIGS. 6A, 6B, and 6C show a schematic diagram of driving method corresponding to continuous two frames, an optical response OP_{N/2} to pixels in the N/2-th row when the luminance of backlight is made constant with time, and optical responses OPB1_{N/2} (for BL1) and OPB2_{N/2} (for BL2) when backlight is turned ON and OFF at timing of BL1, BL2 in the drawing.

Reference symbols V_{gl}, V_{gN/2}, and V_{gN} denote voltages on gate lines of the first, N/2-th, and N-th rows, and their time variations are also schematically shown. Within the frame period Tf, scanning is carried out in the scanning period Ts, and all the gate lines are put in a non-scan state in the hold period Th.

Explanation will be made in connection with an example wherein the scanning period Ts is set at about 16.6 ms (≈ 1/60 seconds) and the hold period Th is set at about 50 ms. In this case, the frame period Tf is about 66.6 ms (≈ 1/15 seconds). The liquid crystal display system is a normally open mode wherein white is displayed when a liquid crystal voltage is zero.

Explanation will then be made as to an optical response OP_{N/2} shown in FIG. 6A. A pulsative optical response change takes place in the scanning period Ts, and the amplitude of the liquid crystal voltage is gradually reduced due to a leakage current in the hold period Th. Thus, when the luminance of backlight is made constant with time, the luminance of the liquid crystal panel is increased.

In the present embodiment, explanation will be made not only as to the pulsative optical response change but also as to how to suppress even an optical response change caused by the leakage current in the hold period Th.

Backlight control in the present embodiment will be explained. Reference symbols BL1 and BL2 shown in FIGS. 6B and 6C denote time variations in the backlight luminance. Ordinate denotes luminance and abscissa denotes time.

Even in any of the time variations BL1 and BL2, the length of the BL period is about 1/60 seconds, and all the BL periods have each an equal length corresponding to ¼ of the frame period Tf. Accordingly, in the frame period Tf, backlight is turned ON four times, and its turn-ON frequency is about 60 Hz.

Within the first BL period T_{BL1}, the panel is controlled so that backlight is in an OFF state during a part of the optical response OP_{N/2} causing the greatest flicker in the scanning period Ts.

Methods for suppressing an optical response change caused by a leakage current are different between the time variations BL1 and BL2. It is assumed for simplicity that a BL period next to the first BL period TBL1 is a second BL period, a BL period next thereto is a third BL period, and a BL period next thereto is a fourth BL period.

How to control backlight shown in FIG. 6B will be explained. In the time variation BL1, ON periods in the first and second BL periods are made to be the same, the ON period of the third BL period is made shorter than the ON period of the first and second BL periods, and the ON period of the fourth BL period is made shorter than the ON period of the third BL period.

With this, the optical response change of the liquid crystal panel is as shown by OPB1_{N/2} and the luminance level of the third and fourth BL periods becomes high. Since the ON period becomes short, however, the integrated values of luminances in the BL periods within one frame period Tf become nearly the same. Thus, the optical response change OPB1_{N/2} of the liquid crystal panel cannot be perceived as flicker.

In the present embodiment, the display mode of the liquid crystal panel is the normally open mode. Thus, the optical response change caused by the leakage current is suppressed, by controlling the panel in such a manner that the ON periods in the BL periods are made gradually smaller with time in the hold period Th (referring to the second to fourth BL periods in the present embodiment).

When the display mode of the liquid crystal panel is a normally close mode. The luminance is gradually reduced. Thus, it is only required to make the ON periods of the BL periods gradually larger with time in the hold period Th.

Explanation will next be made as to how to control backlight shown in FIG. 6C. In the time variation BL2, the ON periods are equal. However, the backlight luminances of the ON periods of the first and second BL periods are made equal, the backlight luminance of the third BL period is made smaller than the backlight luminance of the first and second BL periods, and the backlight luminance of the fourth BL period is made smaller than the backlight luminance of the third BL period.

With it, the optical response change of the liquid crystal panel is as shown by OPB2_{N/2}, and an increase in the luminance caused by the liquid crystal response and a decrease in the backlight luminance cancel each other out. As a result, the luminance levels of the BL periods at the ON time become substantially equal, and the optical response change OPB2_{N/2} of the liquid crystal panel cannot be perceived as flicker.

In the present embodiment, the display mode of the liquid crystal panel is the normally open mode. Therefore, when durations where backlight luminance is made gradually smaller (referring to the second to fourth BL periods in the present embodiment) are provided, the optical response change caused by the leakage current can be suppressed.

When the display mode of the liquid crystal panel is the normally close mode, on the other hand, the luminance becomes gradually smaller. Thus, it is only required to provide such durations that the backlight luminance is made gradually larger.

In the embodiments 1 to 5, the driving of the gate lines and the common electrode has been made by the common-electrode AC frame-inversion driving method. However, even when the driving is carried out by a column-inversion driving method, a line-inversion driving method, or a dot-inversion driving method, or is carried out by different driving methods between the scanning period and the hold period; the backlight control method explained in the embodiments 1 to 5 can effectively suppress flicker.

The word “OFF” as used in the embodiments 1 to 5 will be defined as follows. It refers to a state wherein backlight is in a complete OFF state or to a state wherein a signal for turning OFF the backlight is supplied to a circuit for supplying power to the backlight, as a matter of course. In the present invention, however, the OFF also refers to a state wherein the backlight is in an ON state, but when the luminance is diminished to a level much lower than the luminance in the full ON state, the present invention can exhibit the aforementioned effect.

For example, when picture data as white is given to the pixels of the liquid crystal panel and when the luminance of the liquid crystal panel in the ON state is 100 cd/m² in measurement in a dark room, the luminance of the liquid crystal panel in a light diminished state is about 1-5 cd/m² or lower, the state may be considered to be the OFF state.

In other words, when the luminance level in the light diminished state is about 1/100− 1/20 cd/m² or lower, the state can be considered to be the OFF state, because it can exhibit the effect of the present invention.

### Embodiment 6

Explanation will be made as to an embodiment 6 of the present invention. The foregoing embodiments 1 to 5 of the present invention relate to a driving method for suppressing the deterioration of a picture quality and reducing power consumption. In addition to this, the present embodiment is directed to a liquid-crystal display device.

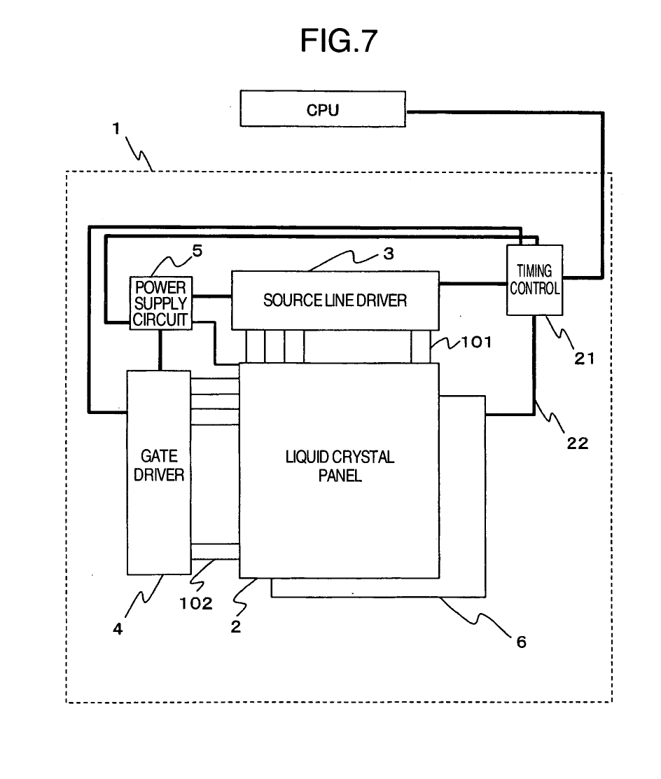

FIG. 7 shows a block diagram for explaining the present embodiment. A liquid crystal panel 2 is illuminated from a backlight unit 6 and a desired picture is displayed thereon. Data lines 101 arranged in the liquid crystal panel 2 are driven by a source line driver 3, and gate lines 102 arranged therein are driven by a gate driver 4.

A power supply circuit 5 supplies power to the source line driver 3 and the gate driver 4. The power supply circuit 5 also has a circuit for driving a common electrode built therein.

A timing control circuit 21 controls the timing of the source line driver 3 and the gate driver 4 and the turning ON and OFF of the backlight unit 6.

A group of BL control signals 22 for controlling the backlight unit 6 is connected to the timing control circuit 21 and the backlight unit 6. The BL control signal group 22 may provide a plurality of signals or may provide a single signal.

An external control circuit (CPU in the present embodiment) such as a CPU or a graphic controller provided outside the liquid-crystal display device, is built in a product having the liquid-crystal display device installed therein. The external control circuit sends image data, data (which will be referred to instruction, in the present embodiment) prescribing the operation of the timing control circuit 21, or a display synchronizing signal to the timing control circuit 21.

The timing control circuit 21 may be a CPU outside the liquid-crystal display device or be installed in the liquid-crystal display device. Or the timing control circuit may be incorporated in the source line driver 3.

These circuits including the gate driver 4 and the power supply circuit 5 can be provided in separated LSIs, or some or all of the circuits can be provided partly or wholly in a common LSI. Or some or all of the circuits can be built in the liquid crystal panel 2 or the backlight unit 6. In this example, explanation will be made in connection with a case where these circuits are provided in separated LSIs.

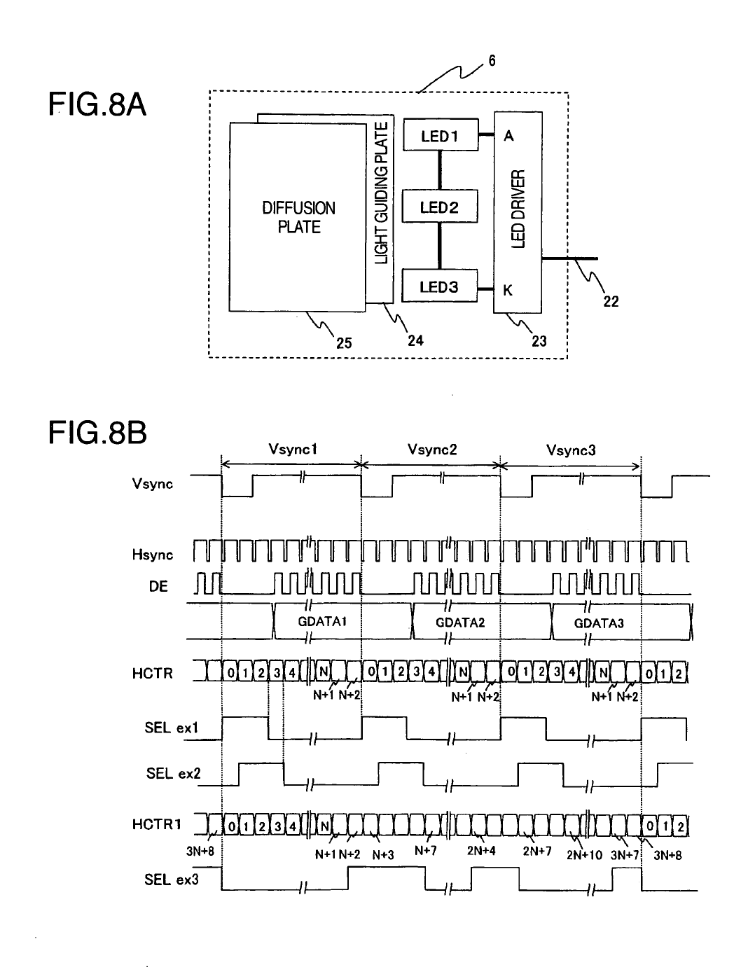

How to control the backlight unit 6 will be explained by referring to FIGS. 8A and 8B. FIG. 8A shows a block diagram of the backlight unit 6. The backlight unit 6 includes, as its main components, a light guiding plate 24, a diffusion plate 25, light emitting diodes LED1 to LED3, and an LED driver 23 for driving the light emitting diodes.

In the present embodiment, the light emitting diode is a white color LED. The light emitting diodes LED1 to LED3 are connected in series. The LED driver 23, on the basis of a control signal SEL which is one of the group 22 of BL control signals received from the timing control circuit 21, supplies power to the light emitting diodes LED1 to LED3.

An anode of the light emitting diode LED1 is connected to a terminal A of the LED driver, a cathode of the light emitting diode LED1 is connected to an anode of the light emitting diode LED2, a cathode of the light emitting diode LED2 is connected to an anode of the light emitting diode LED3, and a cathode of the light emitting diode LED3 is connected to a terminal K of the LED driver.

The terminal A of the LED driver is set either at a voltage higher than that at the terminal K or at a same voltage on the basis of the control signal SEL. Power to the LED driver 23 may be supplied from an external device outside the liquid-crystal display device or may be supplied from the power supply circuit 5. In this example, explanation has been made in the example wherein the light emitting diodes are connected in series. However, the light emitting diodes may be connected in parallel, be controlled collectively or independently, or be connected in combination of series and parallel connections. Further, although the light emitting diode has been a white color LED, the light emitting diodes may form LEDs of single colors of red (R), green (G) and blue (B), and the light emitting diodes may be controlled for each color.

The control signal SEL takes two states. When the control signal SEL takes a first state, the LED driver supplies a voltage to the light emitting diodes LED1 to LED3 to cause a current to flow therethrough for light emission. When the control signal SEL has a second state, the LED driver puts the light emitting diodes LED1 to LED3 in a voltage non-application state to cause the diodes to be turned OFF.

It is assumed in the following explanation that the first state of the control signal SEL is when the voltage of the control signal SEL is at “high” level, and that the second state of the control signal SEL is when the voltage of the control signal SEL is at “low” level.

The control sequence of the timing control circuit 21 will be explained by using FIG. 8B. A display synchronizing signal includes a vertical synchronizing signal (referred to as the signal V_{sync}, hereinafter), a horizontal synchronizing signal (referred to as the signal H_{sync}, hereinafter), a data-enable signal (referred to as the signal DE, hereinafter), and a dot clock signal (referred to as the signal CLK, hereinafter). These signals are operated as shown in FIG. 8B. The CLK is not illustrated.

In a usual mode, the frame period is set at about 1/60 seconds, and the hold period is set to be sufficiently shorter than the scanning period. The scanning period is set at about 16 ms and the remainder of the frame period is used as the hold period. The hold period in such a case is generally called a vertical blanking period. In this case, the signal V_{sync} is a signal for prescribing the frame period, and the period of the signal V_{sync} corresponds to the frame period.

In the present embodiment, a frequency Fv of the signal V_{sync} is set at 60 Hz. The signal H_{sync} is a signal for prescribing a period for scanning of one row, and is operated at a frequency Fh with which a total number N of gate lines can be scanned within one period of the signal V_{sync}. A relation between the frequencies Fv and Fh is Fv<Fh/N.

When the data-enable signal DE is at “HIGH” level, image data becomes effective. Image data GDATA1 to GDATA3 each indicate data corresponding to one frame.

In the signal DE of the drawing, there is present a period where the signal DE is always at “LOW” level for several pulses of the signal H_{sync}. The no-pulse period is called the vertical blanking period. The vertical blanking period has a length of from several tens of us to about 1 ms.

When it is desired to make the frame period equal to one period of the signal V_{sync} the timing control circuit 21 controls the source line driver 3 and the gate driver 4 in such a manner as to display the image data GDATA1 to GDATA3 for each signal V_{sync} according to the signal H_{sync} and the signal DE.

The backlight unit 6 is controlled to be always at “HIGH” level, or to repeat “HIGH” and “LOW” at a frequency (of about 200 Hz) much faster than 60 Hz.

When the frame period has a length corresponding to three periods of the signal V_{sync} (frame frequency being 20 Hz), the scanning period is set at about 1/60 seconds (a time length from about 15 ms to about 16.5 ms other than the vertical blanking period present in one period of the signal V_{sync}) When the hold period is set at about 2/60 seconds, for simplicity, one period of one signal V_{sync} is denoted by Vsync1, one period of the next signal V_{sync} is denoted by Vsync2, and one period of the next signal V_{sync} is denoted by Vsync3, and so on, in the following explanation.

In the period Vsync1, as mentioned above, the timing control circuit 21 controls the source line driver 3 and the gate driver 4 in such a manner as to display the image data GDATA1 according to and the signal H_{sync} and the signal DE supplied from an external device.

And in the two periods Vsync2 and Vsynch3, the timing control circuit 21 controls the gate driver 4 so as to stop the scanning and stop the partial or whole operation of the source line driver 3.

At this time, all the gate lines are at such a voltage level as to turn OFF the TFTs. The gate lines are controlled according to the application purpose by putting the gate lines in a high impedance state, applying a certain level of voltage to the gate lines, or short-circuiting all the gate lines.

However, it is necessary for the source line driver 3 to be able to stop the power of an operational amplifier for current amplification and for charging/discharging of the gate lines. This is because the operational amplifier consumes a highest power in the source line driver, and thus when the power of the operational amplifier is stopped, the power consumption of the source line driver can be reduced to a large extent.

Since it is unnecessary for the source line driver 3 and the gate driver 4 to operate the logic circuit, the power of the logic circuit can also be reduced.

In this case, a power required at the stopped circuit of the some driver can be reduced to about ⅓ of a power required when the frame period is set to be equal to one period of the signal V_{sync}. The hold period is about double of the scanning period and the frame period is about triple thereof.

The signal V_{sync} is used as a signal for prescribing the BL period, and the BL period is set at 1/60 seconds that is equal to one period of the signal V_{sync}. A counter HCTR is a counter for counting the signal H_{sync}, and has a zero count value at a falling edge of the signal V_{sync} By controlling the control signal SEL using the counter HCTR, the timing of turning ON and OFF of the backlight unit can be easily controlled.

For example, as shown by SELex1 in FIG. 8B, when the counter HCTR has 0, the control signal SEL is changed from “LOW” to “HIGH” level; and when the counter HCTR has 3, the control signal SEL is changed from “HIGH” to “LOW” level. As a result, the BL period can be easily prescribed, and such control can be easily realized as to make a sum of the lengths of m (three in the present embodiment) of BL periods equal to the frame period and to make the backlight OFF period in the scanning period longer than the backlight ON period in the scanning period.

Further, the start time of the BL period and the start time of the scanning period (in the present embodiment, when the signal DE in the period Vsync1 starts repetitive “HIGH” and “LOW” level for each 1H period (when the counter HCTR has 3 in the drawing)) can also be easily made different from each other.

For example, as shown by SELex2 in FIG. 8B, when the counter HCTR has 1, the control signal SEL is changed from “LOW” to “HIGH” level; whereas, when the counter HCTR has 4, the control signal SEL is changed from “HIGH” to “LOW” level.

More specifically, when a liquid crystal panel having a line number of 320 rows is used, the counter HCTR takes a count value in a range from 0 to about 340 including the vertical blanking period (of 0.98 ms as an example). At this time, the signal H_{sync} is operated with a period of 49 μs. When the counter HCTR has 20, scanning is started. When the delay period Tᵣₑₜ is set at about 2.5 ms and the ON ratio is at about 50%; the control signal SEL is only required to be changed from “LOW” to “HIGH” level when the counter HCTR has 241; whereas, the control signal SEL is only required to be changed from “HIGH” to “LOW” level when the counter HCTR has 71.

As mentioned above, by using the signal V_{sync} as a signal for prescribing the BL period, setting the value of the counter at zero (that can be set at an arbitrary value including 0 or 1 as the initial value of the counter) at a falling edge of the signal V_{sync}, providing the counter for counting the signal H_{sync}, and using the H_{sync} counter; the backlight control can be easily achieved.

Further, when such counters are used, the length of the BL period and the ON ratio can be specified by arbitrary integer values. The specifying method can be simply realized by using an instruction.

Further the method can be realized by using such a counter HCTR1 as shown in FIG. 8B. The counter HCTR1 is operated to take a count value of zero at a falling edge of the signal V_{sync} in the period Vsync1 positioned at the beginning of the frame period and to count the signal H_{sync} until the last signal H_{sync} of the period Vsync3. When the counter HCTR1 is used, the length of each BL period can be arbitrarily adjusted and an ON ratio can be arbitrarily controlled in the BL period.

For example, it is only required as shown by SELex3 in FIG. 8B to change the control signal SEL from “LOW” to “HIGH” level when the counter HCTR1 has a value of (N+2), (2N+4), and (3N+7); while, to change the control signal SEL from “HIGH” to “LOW” level when the counter HCTR has a value of 0, (N+7), and (2N+7). Since such a counter is employed, the length and ON ratio of the BL period can be specified at arbitrary integer values. The specifying method can be easily realized by using an instruction.

Further, the control of the control signal SEL may be realized not only by using such a counter as to count the signal H_{sync} but also by using a counter which counts a signal generated by the timing control circuit 21 based on a counter counting the signal CLK or the signal DE or on the signal CLK.

Since the timing control circuit 21 can control the driving timing of the source line driver 3 and the gate driver 4 and control the state of the control signal SEL, the turning ON and OFF of the backlight unit can be easily controlled at desired timing.

As a method for modifying the length of the frame period, the modification may be carried out according to an instruction issued from the CPU. Or, when a memory for holding image data in the timing control circuit 21 and when the image data sent from the CPU is not changed throughout two periods or more of the signal V_{sync}, the length of the frame period may be set at a length corresponding to several periods of the signal V_{sync}.

When the memory is built in, the length of the scanning period can be set to be shorter than one period of the signal V_{sync}. Since data so far stored in the memory during the hold period positioned immediately before the scanning period is used, the need for performing the scanning operation in synchronism with the signal H_{sync} through the one full period of the signal V_{sync} can be eliminated and the length of the scanning period can be made short.

An external control circuit may be used to set one period of the signal V_{sync} to be shorter than 1/60 seconds and to control the signals CLK, H_{sync}, and DE in such a manner that the scanning period has a length of 1/60 seconds or smaller. Further, the control of the control signal SEL may be carried out within the liquid-crystal display device and be realized by the counter which counts any signal input to the timing control circuit 21.

### Embodiment 7

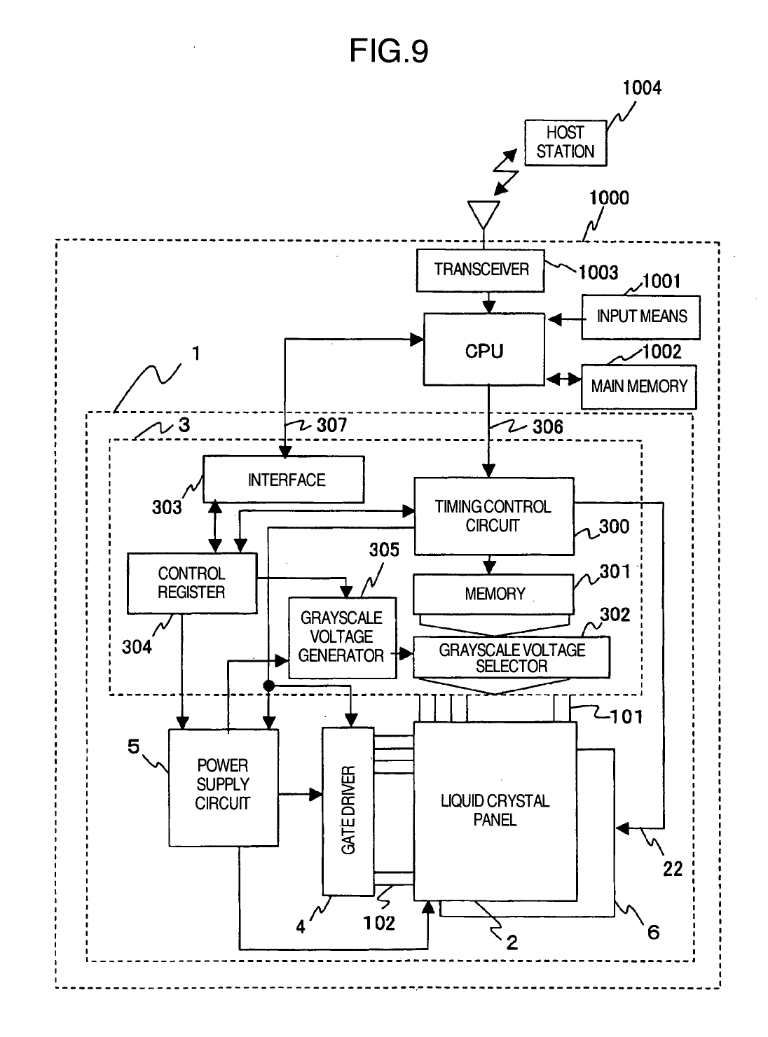

Explanation will be directed to an embodiment 7 of the present invention. FIG. 9 is a block diagram when the present invention is applied to a cellular phone. In FIG. 9, reference numeral 1004 denotes a host station and numeral 1000 denotes a cellular phone.

The cellular phone includes, as its main constituent elements, an input means 1001, a main memory 1002, a transceiver 1003, a CPU, and a liquid-crystal display device 1. The liquid-crystal display device includes, as its main constituent elements, a liquid crystal panel 2, a source line driver 3, a gate driver 4, a power supply circuit 5, and a backlight unit 6.

The source line driver 3 further has, as its constituent elements, a timing control circuit 300, a memory 301, a grayscale voltage selector 302, an interface 303, a control register 304, and a grayscale voltage generator 305.

The CPU in the cellular phone 1000 performs various sorts of operation and control for the cellular phone. With respect to the control of the liquid-crystal display device 1, a display synchronizing signal or image data 306 is output to the timing control circuit 300 so that the display device can display information received from the host station 1004 or data recorded in the main memory 1002. The CPU also issues data 307 (which is referred to as instruction, in the present embodiment) for prescribing the operation.

The interface 303 performs transfer of data including the instruction to the CPU and also performs data transfer to the control register 304. The instruction is stored in the control register 304.

The source line driver 3 drives the data line 101, and the gate driver 4 drives the gate lines 102. The power supply circuit 5, on the basis of a voltage supplied from the cellular phone, supplies a power voltage to the source line driver 3 and the gate driver 4. The power supply circuit 5 also incorporates a circuit for driving a common electrode.

The BL control signal group 22 for controlling the backlight unit 6 is connected to the timing control circuit 300 in the source line driver 3 and to the backlight unit. The timing control circuit 300 controls the driving timing of the data line 101 and the gate lines 102 of the gate driver 4 and the timing of turning ON and OFF of the backlight unit 6.

Explanation will now be made as to how to switch between a mode (referred to as fulltime-ON mode) in which the backlight unit is always put in an fulltime-ON mode through at least one frame, and a mode (referred to as flicker-suppressed ON mode) in which the backlight is turned ON and OFF at predetermined timing (of suppressing such flicker as described in the embodiments 1 to 5).

In the first mode switching method, the CPU judges the surrounding environment of the cellular phone and the switching is carried between the fulltime-ON mode and the flicker-suppressed ON mode. In the flicker-suppressed ON mode when compared with the fulltime-ON mode, the backlight is turned OFF in order to suppress an optical response change in the scanning period. Thus, when the luminance of the ON period is set to be equal to the luminance in the fulltime-ON mode, the luminance of the liquid crystal panel is lower than that in the fulltime-ON mode.

The maximum luminance (usually in the fulltime-ON mode) of a liquid crystal panel in the existing cellular phone is in a range of about from 150 cd/m² to 200 cd/m², and is at such a level as sufficient in an environment such as an office or a living room at home having a luminance of about 500 Lx or in such an environment as a dark place lower than 500 Lx. In a dark environment, it is desirable to reduce the power consumption of the backlight unit and to set the luminance of the liquid crystal panel at a visible level.

To this end, for example, a sensor for judging a surrounding luminance is provided in the cellular phone. On the basis of the value of the sensor, the CPU judges the surrounding luminance and issues an instruction to switch between the fulltime-ON mode and the flicker-suppressed ON mode. On the basis of the data, the timing control circuit 300 switches between the fulltime-ON mode and the flicker-suppressed ON mode.

The instruction LM is designed so that, when an instruction LM has a value of “0”, the liquid-crystal display device is put in the fulltime-ON mode; whereas, when the instruction LM has a value of “1”, the liquid-crystal display device is put in the flicker-suppressed ON mode. The CPU is arranged to cause the instruction LM to have a value of “0” when the value of the sensor is larger than a certain value and to have a value of “1” when the sensor value is lower than the certain value.

The instruction LM can take a plurality of values (e.g., from “0” to “4”) which indicate degrees or levels of luminance. In this case, on the basis of the value of the instruction LM, the timing control circuit 300 controls the ON ratio or the timing of turning ON and OFF.

In the second mode switching method, when any input is provided to the input means 1001 or when the cellular phone receives a signal or a mail, the fulltime-ON mode may be provided. And after passage of several seconds or several minutes from the fulltime-ON mode, the mode may be changed to the flicker-suppressed ON mode.

In this connection, a time necessary for changing the mode from the fulltime-ON mode to the flicker-suppressed ON mode may be stored in the memory of the cellular phone or be set at an arbitrary value by the user of the cellular phone, prior to the product is shipped from a factory or the like.

In the third mode switching mode, such an item as to allow the user to use the cellular phone with a low power consumption may be previously added in a menu for setting of the cellular phone by the user. And when the user selects the item, this may cause the cellular phone to be put in the flicker-suppressed ON mode.

Or, when dot-inversion driving method is not modified for a time length of 1/60 seconds or more and in the aforementioned situations, the CPU may be designed to issue an instruction to put the device in the flicker-suppressed ON mode.

As another modification, the timing control circuit 300 may judge the fact that image data is not changed for a time length of 1/60 seconds or more and that the instruction data means to change to the flicker-suppressed ON mode, and may control the flicker-suppressed ON mode. Further, the timing control circuit 300 may judge the value of the sensor or no change of image data for a time length of 1/60 seconds or more and may change to the flicker-suppressed ON mode.

In the foregoing, explanation has been made as to how to switch between the fulltime-ON mode and the flicker-suppressed ON mode. However, the present invention is not limited to the specific example, but the invention may employ a mode switching method between the flicker-suppressed ON mode and another mode (for example, an ON/OFF mode in which such a hold period as to have a length corresponding nearly to the scanning period or longer is not provided), as a matter of course.

Explanation will next be made as to timing control when the liquid-crystal display device is in the flicker-suppressed ON mode. The display synchronizing signal or image data 306 is input from the CPU to the timing control circuit 300. The timing control circuit 300 in turn controls the memory 301 to write the image data at a predetermined address in the memory.

The timing control circuit 300 reads out the image data from the memory 301, and sequentially outputs the image data corresponding to one line to the grayscale voltage selector 302. The grayscale voltage selector 302 selects any of grayscale voltages generated by the grayscale voltage generator 305 according to the image data and applies it to the data line 101. The grayscale voltage generator 305 generates grayscale voltages corresponding to all grayscales (and generates 64 grayscale voltages for display at 64 voltage levels).

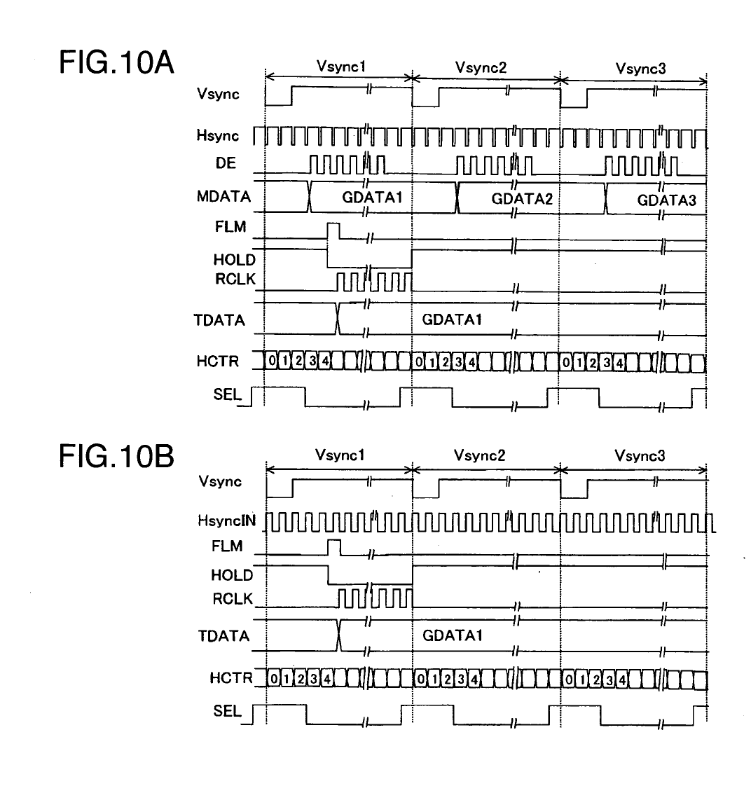

Such a timing chart is shown in FIG. 10A. In this case, the contents of the display synchronizing signal or image data 306 are assumed to be the same as those already explained in the embodiment 6.

FIG. 10A shows the timing chart when the frame period has a length corresponding to three periods (with a frame frequency of 20 Hz) of the signal V_{sync} and when the scanning period is about 1/60 seconds and the hold period is about 2/60 seconds. The scanning period is included in the period Vsync1. Reference symbol MDATA indicates data MDATA in the memory 301.

Image data corresponding to one line is sequentially written in the memory 301 for each signal H_{sync} in synchronism with a signal CLK (not shown) when the signal DE is at “HIGH” level. A signal FLM instructs the frame start.

A signal HOLD is a signal for prescribing the hold period and becomes “LOW” level at a rising edge of the signal FLM. The signal HOLD is changed again to “HIGH” level at a falling edge of the signal V_{sync} in the period of the period Vsync2 or after the writing operation is finished.

A signal RCLK is used to instruct the timing of reading out image data corresponding to one line from the memory and sequentially outputting the read-out data to the grayscale voltage selector 302. Reference symbol TDATA denotes data already given to the grayscale voltage selector 302.

While the signal HOLD is at “HIGH” level, the output of the grayscale voltage generator 305 acts as a high impedance and to stop or reduce a current flowing through the grayscale voltage generator 305. The signal RCLK is stopped the reading-out operation of the memory is stopped. When the scanning is completed, further, a voltage for turning OFF the TFT is given to the gate line. As a result, the driving power can be reduced.

The control of the control signal SEL is only required to be carried out by using the counter HCTR, the counter HCTR1, and so on. Thus, by setting a sum of lengths of an arbitrary number of BL periods at a value equal to the frame period, the turning ON and OFF of the backlight unit can be easily controlled at desired timing.

Although the present embodiment has been explained in connection with the example wherein image data corresponding to one frame is transmitted for each signal V_{sync}, it is unnecessary to transmit such image data in the periods Vsync2 and Vsync3. In this manner, a power necessary for the data transmission can be reduced.

Further, when the CPU controls the value of the signal DE in the periods Vsync2 and Vsync3 to have always a level of “LOW”, the writing operation of the memory can also be stopped. At this time, a power necessary for the memory writing and for the signal DE transmission can be reduced.

When the scanning period is set shorter than the period of the signal V_{sync} (for example, set at half of 1/120 seconds), the memory reading-out is carried out at the timing of the period Vsync1, the writing of the image data in the memory is carried out at the timing of the period Vsync3, and no memory writing is carried out in the periods Vsync1 and Vsync2, as mentioned above. As a result, the delay of display of the image data to the liquid crystal panel is only required to correspond to one period of the signal V_{sync}.

When the CPU control the signals CLK, H_{sync}, and DE at a fast period, the scanning period may be made short.

Explanation will then be made in connection with a case wherein an oscillation circuit is built in the source line driver 3, by using a timing chart of FIG. 10B. In this case, since an internal clock signal (not shown) is generated in the oscillation circuit, the need for the CPU to transmit the signals CLK, H_{sync}, and DE to the source line driver 3 can be eliminated.

The internal clock signal is a clock signal which is shorter than a one-line scanning period and synchronizes with the signal V_{sync}. The internal clock signal is used to generate a signal HsyncIN. The control signal SEL is controlled by counting the signal HsyncIN.

The frequency of the internal clock signal or a signal to be generated in the oscillation circuit may be arbitrarily set. Accordingly, the frequency of the internal clock signal can be made high and the scanning period can be set shorter than the period of the signal V_{sync} (for example, at a value corresponding to half of 1/120 seconds).

In this case, the transmission of the image data from the CPU starts with a falling edge of the period Vsync1 in the period Vsync1 to start the writing operation of the image data in the memory. The reading-out of the image data by the signal RCLK starts with the signal FLM rising later than the period Vsync1 as a reference. The reading and writing of the image data are shifted from each other, the image data is transmitted from the CPU within the same period Vsync1, written, and then later read out.

The frequency of the internal clock signal is made high, and the reading and writing of the image data are shifted from each other. Thus even when the scanning period is set sorter than the period of the period Vsync1, the display delay of the image data to the liquid crystal panel can be set at a time nearly corresponding to a time difference between the falling of the signal V_{sync} and the falling of the signal FLM.

In addition, the capacity of the memory can be made smaller than that of the frame memory. In other words, the capacity of the memory can be set at such a value that image data transmitted during a time length from the falling of the signal V_{sync} to the falling of the signal FLM can be held therein.

The refresh rate of image data sent from a digital camera, a digital still camera built in a cellular phone, or from the Internet, mobile broadcast, etc. is 30 Hz or 15 Hz that is smaller than 60 Hz. Therefore, when the transmission and reading-out operation of the image data is carried out in the aforementioned manner by synchronizing the period Vsync1 to the timing of the refresh rate of the image data, the delay of display of the image data to the liquid crystal panel can be made small.

In this case, the CPU transmits the image data in the period Vsync1, while eliminating the need for the CPU to transmit the data in periods Vsync2 and Vsync3. Only when the image data is varied, the transmission of the image data may be carried out. When the data is of a still type, the transmission of the signal V_{sync} can also be stopped.

The period of the signal V_{sync} may be set not at 1/60 seconds but at a value equal to the frame period (at 1/20 seconds in the present embodiment), and the driving of the gate and gate lines may be carried out with use of the internal clock signal as a reference.

In this case, a main different point is the control of the BL period. The control of the BL period can be easily realized by using such a counter as the counter HCTR1 shown in the embodiment 6 for counting any of internal signals through the frame period or using a counter for returning its count value to an initial value for each period corresponding to 1/n (n being an integer of 2 or larger) of the frame period.

### Embodiment 8

Explanation will be made as to an embodiment 8 of the present invention. As already explained in the embodiment 1 of the present invention, first of all, an optical response change in the hold period Th is substantially zero, the luminance is constant, and the lower the optical response change is, the greater the optical response change is in the scanning period Ts.

It will be seen from FIG. 2 that, when the relative luminance is generally not smaller than 50%, substantially no flicker takes place. The main reason is that, when the relative luminance is higher than 50%, a voltage to be applied to the liquid crystal becomes low, which results in that the amplitude of the gate line becomes also small, and a variation in the liquid crystal voltage caused by the capacitive coupling between the gate line and the pixel electrode becomes small.

At this time, a voltage corresponding to a relative luminance of 0% is about 4V, a voltage corresponding to a relative luminance of 12.5% is about 2.55V, a voltage corresponding to a relative luminance of 50% is about 1.92V, a voltage corresponding to a relative luminance of 82.5% is about 1.52V, and a voltage corresponding to a relative luminance of 100% is about 0.5V. Accordingly, a dynamic range as a range of possible values of voltages to be applied to the pixel liquid crystal layer is 3.5V. In other words, a dynamic range of voltages to be applied to the gate line is also from about 3.5V to about 4V.

When it is desired in a certain frame to display image data compatible with a relative luminance lower than 50%, flicker can be suppressed, by lowering the quantity of backlight and simultaneously applying to the liquid crystal a voltage corresponding to image data compatible with a relative luminance higher than the image data.

In this case, since the voltage to be applied to the liquid crystal can be decreased and the amplitude of the gate line can be made small; flicker, which occurs in the scanning period and involves a problem when the frame frequency is made smaller than 60 Hz, can be suppressed.

In this case, the quantity of backlight is lowered. Since the voltage to be applied to the liquid crystal is reduced to increase a ratio of light passing through the liquid crystal layer, however, the liquid crystal panel can display substantially the same picture as before the quantity of backlight is lowered. The quantity of backlight may be lowered by providing PWM control. In this case, such a control method as explained in the embodiments 1 to 5 of the present invention may be employed. Further, the quantity of backlight may be lowered by decreasing the level of luminance caused by the backlight.

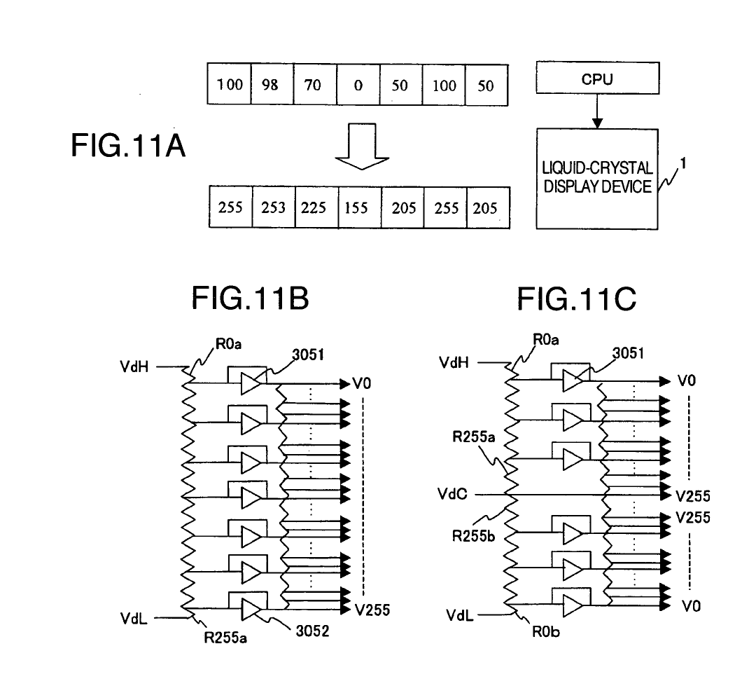

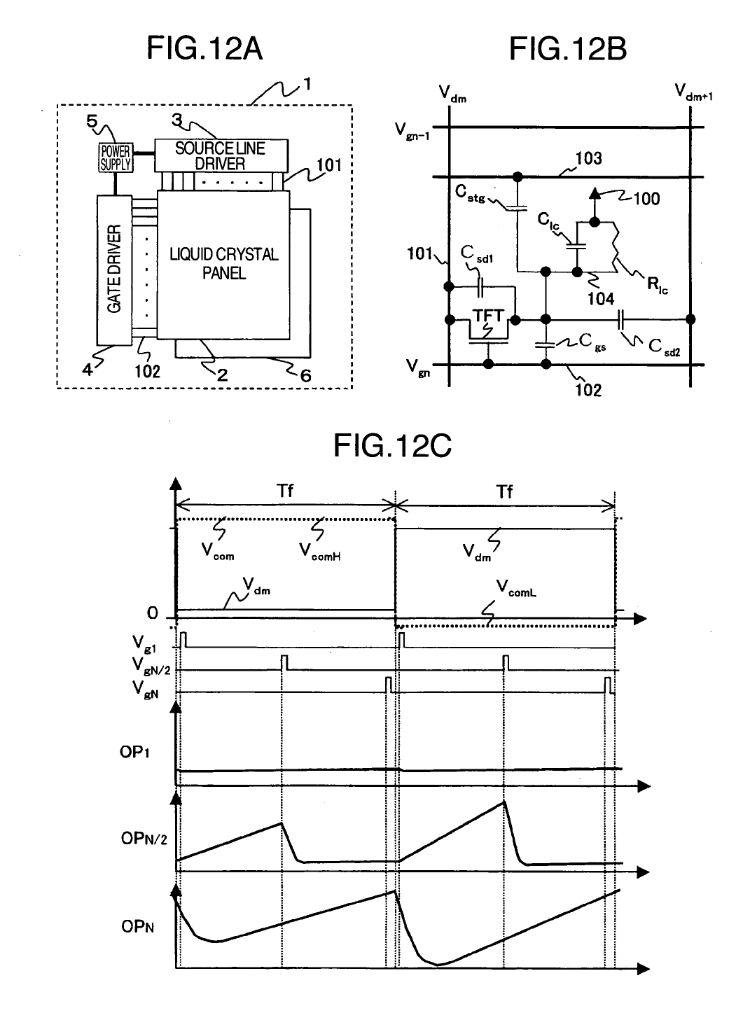

As one of methods for narrowing the dynamic range as the possible range of voltages to be applied to the pixel liquid crystal layer and decreasing the voltage to be applied to the liquid crystal, it is considered to convert image data. This will be explained by using FIGS. 11A, 11B, and 11C.

The liquid-crystal display device 1 is assumed to be able to display an image at grayscale levels of 256 (from 255 to 0). Numbers shown by (a), in FIG. 11A denote image data given to pixels sent from an external CPU. In this case, the image data has a maximum value of 100. A circuit in the liquid-crystal display device 1 judges the maximum value on the basis of the image data being set from the CPU, and converts the image data based on the judgment result.

For example, as shown by (b) in FIG. 11A, a tone 100 is converted to 255, a tone 99 is converted to 254, a tone 98 is converted to 253, . . . , and then a tone 0 is converted to 155, sequentially. In this case, the tone has been decremented sequentially by one grayscale, but the present invention is not limited to such sequential conversion. For example, it is also possible to convert a set of tones 100 to 0, to a range from 255 to 126, or to a range from 226 to 126. In other words, a set of low tones may be converted to a set of high tones. Thus, when the display mode of the liquid crystal panel is a normally open mode, a voltage to be applied to the liquid crystal can be lowered. At this time, the quantity of backlight is set at a small value.

Explanation will next be made as to a method for controlling the grayscale voltage generator to make the dynamic range small. FIGS. 11B and 11C show circuit diagrams for generating grayscale voltages respectively. Each grayscale voltage is obtained by resistor-dividing a voltage between a voltage VdH and a voltage VdL (Vdh>VdL). FIG. 11C shows a circuit for generating 256 voltages ranging from a voltage V0 to a voltage V255.

Reference symbol R0a denotes a resistance between a wiring line for supplying the voltage VdH and a wiring line having an operational amplifier 3051 for outputting a voltage V0; and symbol R255a denotes a resistance between a wiring line for supplying the voltage VdL and a wiring line having an operational amplifier 3052 for outputting the voltage V255.

In order to make small the dynamic range of the voltage to be applied to the liquid crystal, it is only required to make small the voltage between the voltage VdH and the voltage VdL. For example, in a common-electrode AC frame-inversion driving method, it is only required to make the voltage VdL constant and make the voltage VdH small for a positive frame; whereas, it is only required to make the voltage VdH constant and make the voltage VdL large for a negative frame. Even when the values of the resistance R0a and R255a are set large, the dynamic range of the voltage to be applied to the liquid crystal can be made small. In this case, the quantity of backlight is made small.

In FIG. 11C, the positive and negative grayscale voltages V0 to V255 are generated. The number of generated voltages is 511. FIG. 11C is different from FIG. 11B in that the positive grayscale voltages are generated between the voltage VdH and a voltage VdC, and that the negative luminance values are generated between the voltage VdC and the voltage VdL. In this case, by a method similar to the circuit control in FIG. 11B, the dynamic range of the voltage to be applied to the liquid crystal can be made narrow. With the constant voltage VdC, the voltage VdH may be made small and the voltage VdL may be made large, or the resistances R0a and Rob in FIG. 11C may be made large respectively. At this time, the quantity of backlight is set small.

With the aforementioned arrangement and control, the dynamic range of the voltage to be applied to the liquid crystal can be made narrow and the voltage to be applied to the liquid crystal layer can be easily made low.

Since not only the power is reduced due to the reduction of the frame frequency but also the voltage to be applied to the liquid crystal is made small, the power reduction due to the reduced amplitude of the gate line voltage can also be obtained. Further, since the quantity of backlight is lowered, the power of the backlight can also be reduced.

It should be further understood by those skilled in the art that although the foregoing description has been made on embodiments of the invention, the invention is not limited thereto and various changes and modifications may be made without departing from the spirit of the invention and the scope of the appended claims.

1. A method for driving a liquid-crystal display device comprising a liquid crystal panel and a backlight unit, said liquid crystal panel including a pair of substrates, a liquid crystal layer held between said pair of substrates, data and gate lines for applying an electric field to said liquid crystal layer, a plurality of active elements connected at intersections of said data and gate lines, and pixels driven by said active elements, said backlight unit intermittently turning ON and OFF to intermittently irradiate said liquid crystal panel with light, comprising the steps of:
providing a scanning period for providing image data from said data line to said pixels and a hold period for putting all of said gate lines in a non-scan state immediately after said scanning period, said hold period having a length corresponding nearly to said scanning period or longer; setting a sum of said scanning period and said hold period as a frame period, said frame period being continuously repeated, and having a length not shorter than 1/60 seconds; providing a plurality of backlight periods each including an OFF period of said backlight unit and an ON period subsequent to said OFF period, a sum of lengths of said plurality of backlight periods being equal to a length of said frame period; and setting the OFF period of said backlight unit to be longer than the ON period of said backlight unit in said scanning period.

2. A method for driving a liquid-crystal display device comprising a liquid crystal panel and a backlight unit, said liquid crystal panel including a pair of substrates, a liquid crystal layer held between said pair of substrates, data and gate lines for applying an electric field to said liquid crystal layer, a plurality of active elements connected at intersections of said data and gate lines, and pixels driven by said active elements, said backlight unit intermittently turning ON and OFF to intermittently irradiate said liquid crystal panel with light, comprising the steps of:
providing a scanning period for providing image data from said data line to said pixels and a hold period for putting all of said gate lines in a non-scan state immediately after said scanning period, said hold period having a length corresponding nearly to said scanning period or longer; setting a sum of said scanning period and said hold period as a frame period, said frame period being continuously repeated, said frame period having a length not shorter than 1/60 seconds, providing a plurality of backlight periods each including an OFF period of said backlight unit and an ON period subsequent to said OFF period, a sum of lengths of said plurality of backlight periods being equal to a length of said frame period; and when a period after scanning is started until nearly half of all the gate lines to be scanned is scanned is set to be a preceding half of the scanning period and a period until the remaining gate lines are scanned is set to be a succeeding half of the scanning period, setting at least the ON period of said backlight unit in the preceding half of said scanning period, and setting at least the OFF period of said backlight unit in the succeeding half of said scanning period.

3. A method for driving a liquid-crystal display device comprising a liquid crystal panel and a backlight unit, said liquid crystal panel including a pair of substrates, a liquid crystal layer held between said pair of substrates, data and gate lines for applying an electric field to said liquid crystal layer, a plurality of active elements connected at intersections of said data and gate lines, and pixels driven by said active elements, said backlight unit intermittently turning ON and OFF to intermittently irradiate said liquid crystal panel with light, comprising the steps of:
providing a scanning period for providing image data from said data line to said pixels and a hold period for putting all of said gate lines in a non-scan state immediately after said scanning period, said hold period having a length corresponding nearly to said scanning period or longer; setting a sum of said scanning period and said hold period as a frame period, said frame period being continuously repeated, said frame period having a length not shorter than 1/60 seconds; providing backlight periods each including an OFF period of said backlight unit and an ON period subsequent to said OFF period being continuously repeated; turning said backlight unit ON and OFF at least once in said hold period; and setting the OFF period of said backlight unit to be longer than the OFF period of said backlight unit in the scanning period.

4. A method for driving a liquid-crystal display device comprising a liquid crystal panel and a backlight unit, said liquid crystal panel including a pair of substrates, a liquid crystal layer held between said pair of substrates, data and gate lines for applying an electric field to said liquid crystal layer, a plurality of active elements connected at intersections of said data and gate lines, and pixels driven by said active elements, said backlight unit intermittently turning ON and OFF to intermittently irradiate said liquid crystal panel with light, comprising the steps of:
proving a scanning period for providing image data from said data line to said pixels and a hold period for putting all of said gate lines in a non-scan state immediately after said scanning period, said hold period having a length corresponding nearly to said scanning period or longer, a sum of said scanning period and said hold period corresponds to a frame period, said frame period being continuously repeated, said frame period is set to have a length not shorter than 1/60 seconds, providing backlight periods each including an OFF period of said backlight unit and an ON period subsequent to said OFF period being continuously repeated; turning said backlight unit ON and OFF at least once in said hold period; and when a period after scanning is started until nearly half of all the gate lines to be scanned is scanned is set to be a preceding half of the scanning period and a period until the remaining gate lines are scanned is set to be a succeeding half of the scanning period, setting at least the ON period of said backlight unit in the preceding half of said scanning period, and at least the OFF period of said backlight unit in the succeeding half of said scanning period.

5. A driving method according to claim 1 or 2, wherein said backlight period has a length corresponding nearly 1/n (n being an integer of 2 or larger) of one frame period, and said length is not larger than about 1/60 seconds.

6. A driving method according to claim 1 or 2, wherein, when said backlight periods have a plurality of lengths, a sum of lengths of n (n being an integer of 2 or larger) backlight periods is equal to said frame period, and the lengths of the backlight periods are nearly not larger than about 1/60 seconds.

7. A driving method according to claim 1 or 2, wherein, when the backlight period is started with a switching time from ON to OFF in said backlight period, a start time of said scanning period is shifted from a start time of said backlight period.

8. A driving method according to claim 1 or 2, wherein a period after scanning is started until nearly half (N/2 when N is an even number or (N−1)/2 when N is an odd number) of all the N gate lines (N being the number of all the gate lines and being an integer of 1 or larger) to be scanned is scanned is set to be preceding half of the scanning period, a period until the remaining gate lines are scanned is set to be succeeding half of the scanning period, and a first switching time of light of the backlight unit from ON to OFF is present in the preceding half of said scanning period in said scanning period.

9. A driving method according to claim 1 or 2, wherein a length of said backlight period is about 1/60 seconds.

10. A driving method according to claim 1 or 2, wherein a length of said scanning period is shorter than 1/60 seconds.

11. A driving method according to claim 1 or 3, wherein a length of said scanning period is shorter than 1/60 second, and said backlight unit is in an OFF state in the entire scanning period.

12. A driving method according to claim 10, wherein said hold period has a length corresponding to about n times (n being an integer of 1 or larger) said scanning period, and said backlight period has a length corresponding to about m times (m being an integer of 1 or larger) said scanning period.

13. A driving method according to claim 10, wherein said hold period has a period such that said backlight period has a length corresponding to about n times (n being an integer of 1 or larger) the scanning period, and the frame period has a length corresponding to about m times (m being an integer of 1 or larger) said backlight period.

14. A driving method according to claim 1, wherein an ON ratio as an ON period in said backlight period is gradually increased when a display mode of said liquid crystal panel is a normally close mode, and said ON ratio is gradually decreased when the display mode of the liquid crystal panel is a normally open mode.

15. A driving method according to claim 1, wherein said hold period has a period such that a luminance of the backlight is gradually increased when a display mode of the liquid crystal panel is an normally close mode and said backlight luminance is gradually decreased when the display mode of the liquid crystal panel is an a normally open mode.

16. A liquid-crystal display device comprising a liquid crystal panel and a backlight unit, said liquid crystal panel including a pair of substrates, a liquid crystal layer held between said pair of substrates, data and gate lines for applying an electric field to said liquid crystal layer, a plurality of active elements connected at intersections of said data and gate lines, and pixels driven by said active elements, said backlight unit intermittently turning ON and OFF to intermittently irradiate said liquid crystal panel with light,
wherein a light source of said backlight unit is a light emitting diode,
a scanning period for providing image data from said data line to said pixels and a hold period for putting all of said gate lines in a non-scan state immediately after said scanning period are provided,
said hold period has a length corresponding nearly to said scanning period or longer, a sum of said scanning period and said hold period corresponds to a frame period, said frame period is continuously repeated, said frame period is set to have a length not shorter than 1/60 seconds, a plurality of backlight periods each including an OFF period of said backlight unit and an ON period subsequent to said OFF period are provided,
a sum of lengths of said plurality of backlight periods is equal to a length of said frame period, and
a control circuit for controlling an on-off timing of the backlight is provided so that the OFF period of said backlight unit is longer than the ON period of said backlight unit in said scanning period.

17. A liquid-crystal display device comprising a liquid crystal panel and a backlight unit, said liquid crystal panel including a pair of substrates, a liquid crystal layer held between said pair of substrates, data and gate lines for applying an electric field to said liquid crystal layer, a plurality of active elements connected at intersections of said data and gate lines, and pixels driven by said active elements, said backlight unit intermittently turning ON and OFF to intermittently irradiate said liquid crystal panel with light,
wherein a light source of said backlight unit is a light emitting diode, a scanning period for providing image data from said data line to said pixels and a hold period for putting all of said gate lines in a non-scan state immediately after said scanning period are provided, said hold period has a length corresponding nearly to said scanning period or longer, a sum of said scanning period and said hold period corresponds to a frame period, said frame period is continuously repeated, said frame period is set to have a length not shorter than 1/60 seconds, a plurality of backlight periods each including an OFF period of said backlight unit and an ON period subsequent to said OFF period are provided, a sum of lengths of said plurality of backlight periods is equal to a length of said frame period, a period after scanning is started until nearly half of all the gate lines to be scanned is scanned is set to be a preceding half of the scanning period, a period until the remaining gate lines are scanned is set to be a succeeding half of the scanning period, a control circuit for controlling an on-off timing of the backlight is provided so that at least the ON period of said backlight unit is in the preceding half of said scanning period, and at least the OFF period of said backlight unit is in the succeeding half of said scanning period.

18. A liquid-crystal display device according to claim 16 or 17, wherein said control circuit for controlling timing of the backlight is built in a source line driver circuit for controlling data lines for transmission of image data to pixels.

19. A liquid-crystal display device according to claim 18, wherein said source line driver circuit has a memory for recording the image data therein.

20. A liquid-crystal display device according to claim 16 or 17, wherein said control circuit for controlling timing of the backlight has a counter which adjusts a switching time of the backlight from OFF to ON and a switching time of the backlight from ON to OFF using an arbitrary integer value.

21. A liquid-crystal display device according to claim 16 or 17, wherein a control circuit is provided for setting said hold period to have a length corresponding to nearly n times (n being an integer of 1 or larger) said scanning period and setting said backlight period to have a length corresponding to nearly m times (m being an integer of 1 or larger) said scanning period.

22. A liquid-crystal display device according to claim 16 or 17, wherein a control circuit is provided for setting said backlight period to have a length of corresponding to nearly n times (n being an integer of 1 or larger) said scanning period and setting said frame period to have a length corresponding to nearly m times (m being an integer of 1 or larger) said backlight period.

23. A liquid-crystal display device according to claim 16 or 17, wherein said backlight period has a length corresponding to an integral multiple of a period of a signal supplied from outside said liquid-crystal display device.

24. A liquid-crystal display device according to claim 16 or 17, wherein said backlight period has a length corresponding to about 1/n (n being an integer of 1 or larger) a vertical synchronizing signal supplied from outside said liquid-crystal display device.

25. A liquid-crystal display device according to claim 16 or 17, wherein said circuit for controlling the timing of backlight can switch between a mode in which the backlight is put always in an ON state throughout one frame period and a mode in which the backlight unit is turned ON and OFF at predetermined timing in one frame period.

26. A liquid-crystal display device comprising a liquid crystal panel and a backlight unit, said liquid crystal panel including a pair of substrates, a liquid crystal layer held between said pair of substrates, data and gate lines for applying an electric field to said liquid crystal layer, a plurality of active elements connected at intersections of said data and gate lines, and pixels driven by said active elements, said backlight unit intermittently turning ON and OFF to intermittently irradiate said liquid crystal panel with light,
wherein a scanning period for providing image data from said data line to said pixels and a hold period for putting all of said gate lines in a non-scan state immediately after said scanning period are provided, said hold period has a length corresponding nearly to said scanning period or longer, a sum of said scanning period and said hold period corresponds to a frame period, said frame period is continuously repeated, said frame period is set to have a length not shorter than 1/60 seconds, a dynamic range of a voltage to be applied to said data line can be adjusted, said dynamic range is made narrow in an arbitrary frame and simultaneously the quantity of light irradiated by the backlight unit in one frame is made small.

27. A method for driving a liquid-crystal display device comprising a liquid crystal panel and a backlight unit, said liquid crystal panel including a pair of substrates, a liquid crystal layer held between said pair of substrates, data and gate lines for applying an electric field to said liquid crystal layer, a plurality of active elements connected at intersections of said data and gate lines, and pixels driven by said active elements, said backlight unit intermittently turning ON and OFF to intermittently irradiate said liquid crystal panel with light, comprising the steps of:
setting a plurality of backlight periods each having an OFF period of said backlight unit and an ON period subsequent to said OFF period in the frame period in synchronism with a frame period, said frame period having a scanning period for providing image data from said data line to said pixels and also having a hold period for putting all of said gate lines in a non-scan state immediately after said scanning period, said hold period having a length longer than said scanning period, and driving said backlight unit intermittently in said plurality of backlight periods.

28. A liquid-crystal display device comprising a liquid crystal panel and a backlight unit, said liquid crystal panel including a pair of substrates, a liquid crystal layer held between said pair of substrates, data and gate lines for applying an electric field to said liquid crystal layer, a plurality of active elements connected at intersections of said data and gate lines, and pixels driven by said active elements, said backlight unit intermittently turning ON and OFF to intermittently irradiate said liquid crystal panel with light, comprising:
a timing control circuit operable so that a plurality of backlight periods each having an OFF period of said backlight unit and an ON period subsequent to said OFF period are set in the frame period in synchronism with a frame period, said frame period having a scanning period for providing image data from said data line to said pixels and also having a hold period for putting all of said gate lines in a non-scan state immediately after said scanning period, said hold period having a length longer than said scanning period, and said backlight unit is intermittently driven in said plurality of backlight periods.
